(19) United States
(12) Patent Application Publication
(10) Pub. No.: US 2026/0342278 A1
(43) Pub. Date: Oct. 29, 2026

(54) Passive Self-Cooling Modular Solar Assembly

(71) Applicant: RAYVA INC., Gilbert, AZ (US)

(72) Inventors: Cody D. VAN CLEVE, Gilbert, AZ (US); CherryLynne R. NETHKEN, Gilbert, AZ (US)

(21) Appl. No.: 19/657,650

(22) Filed: Apr. 24, 2026

Related U.S. Application Data
(60) Provisional application No. 63/794,016, filed on Apr. 24, 2025.

(51) Int. Cl. H02S 30/10; H02S 20/23; H02S 40/32; H02S 40/42

(52) U.S. Cl. CPC H02S 30/10; H02S 20/23; H02S 40/32; H02S 40/425

(57) ABSTRACT

An assembly for generating solar power having a frame including a left side rail, a right side rail, a rear side header runner, and a front side trim, the left side rail including a left side slot, the right side rail including a right side slot, and the front side trim including a front side slot, the rear side header runner including a first part defining the rear side of the assembly and a second part extending toward an interior of the frame, the frame configured for installation on a roof by fastening the rear side header runner to roof support structure, a solar laminate comprising a solar cell, and a firestop plate comprising a sheet sized and shaped for attachment to the left side rail, the right side rail and the rear side header runner.

### PRIORITY CLAIM

The present application claims priority to U.S. Provisional Patent Application Ser. No. 63/794,016 filed Apr. 24, 2025. The specification of the above-identified application is incorporated herewith by reference.

### FIELD

The present disclosure relates to solar panels that are passively self-cooled.

### BACKGROUND

Building-integrated photovoltaics (BIPV) (building-integrated solar) refers to solar panels or solar modules integrated into the structure of a building, e.g., a roof, a façade or a window. BIPVs can generate electricity while also providing building protection and aesthetic benefits relative to, e.g., some existing roof-mounted solar panels that are mounted on support structure (e.g., a “rack”) elevated above the roof. Rack-mounted solar panels can present several difficulties including, e.g., weakening the integrity of the roof by the additional weight of the panels and racking system in combination with roof penetrations required to attach the rack; panels detaching due to the exposure of the panels to wind forces; difficult and costly installation and maintenance; and/or an aesthetically displeasing appearance.

### SUMMARY

Some example embodiments are related to an assembly for generating solar power having a frame including a left side rail defining a left side of the assembly, a right side rail defining a right side of the assembly, a rear side header runner defining a rear side of the assembly, and a front side trim defining a front side of the assembly, the left side rail including a left side slot, the right side rail including a right side slot, and the front side trim including a front side slot, the rear side header runner including a first part defining the rear side of the assembly and a second part extending toward an interior of the frame, the frame configured for installation on a roof by fastening the rear side header runner to roof support structure, a solar laminate comprising a solar cell, the solar laminate including a left side, a right side, a rear side and a front side, the solar laminate sized and shaped so that the left side thereof is receivable in the left side slot of the left side rail, the right side thereof is receivable in the right side slot of the right side rail, and the front side thereof is receivable in the front side slot of the front side trim and a firestop plate comprising a sheet sized and shaped for attachment to the left side rail, the right side rail and the rear side header runner, the firestop plate including a left side portion fastened to the left side rail, a right side portion fastened to the right side rail, and a rear side portion fastened to the second part of the rear side header runner, wherein the rear side portion of the firestop plate overlaps the second part of the rear side header runner, wherein the solar laminate and the firestop plate are separated by a first distance forming a space therebetween, wherein the firestop plate and the front side trim are separated by a second distance forming a first gap therebetween, wherein the rear side of the solar laminate and the first part of the rear side header runner are separated by a third distance forming a second gap therebetween, and wherein the first gap is in communication with the second gap via the space so that a vent is formed between the solar laminate and the firestop plate, permitting air to flow through the space.

Other example embodiments are related to a system for generating solar power having a first assembly including a first frame including a first left side rail, a first right side rail, a first rear side header runner, and a first front side trim, the first left side rail including a first left side slot, the first right side rail including a first right side slot, and the first front side trim including a first front side slot, a first solar laminate comprising a first solar cell, the first solar laminate sized and shaped to slide within the first left side slot of the first left side rail, the first right side slot of the first right side rail, and the first front side slot of the first front side trim to install the first solar laminate in the first frame and a first firestop plate fastened to the first left side rail, the first right side rail, and the first rear side header runner, wherein the first solar laminate and the first firestop plate are separated by a first space therebetween, wherein the first firestop plate and the first front side trim are separated by a first front gap therebetween, wherein a first rear side of the first solar laminate and a part of the first rear side header runner are separated a first rear gap therebetween, and wherein the first front gap is in communication with the first rear gap via the first space so that a first vent is formed between the first solar laminate and the first firestop plate, permitting air to flow through the first space and a second assembly including a second frame including a second left side rail, a second right side rail, a second rear side header runner, and a second front side trim, the second left side rail including a second left side slot, the second right side rail including a second right side slot, and the second front side trim including a second front side slot, a second solar laminate comprising a second solar cell, the second solar laminate sized and shaped to slide within the second left side slot of the second left side rail, the second right side slot of the second right side rail, and the second front side slot of the second front side trim to install the second solar laminate in the second frame and a second firestop plate fastened to the second left side rail, the second right side rail, and the second rear side header runner, wherein the second solar laminate and the second firestop plate are separated by a second space therebetween, wherein the second firestop plate and the second front side trim are separated by a second front gap therebetween, wherein a second rear side of the second solar laminate and a part of the second rear side header runner are separated a second rear gap therebetween, and wherein the second front gap is in communication with the second rear gap via the second space so that a second vent is formed between the second solar laminate and the second firestop plate, permitting air to flow through the second space, wherein the first frame is configured for installation on a sloped roof plane by fastening the first rear side header runner to a first horizontal member of roof support structure and the second frame is configured for installation on the sloped roof plane by fastening the second rear side header runner to a second horizontal member of the roof support structure, the second horizontal member located higher on the roof plane such that second assembly overlaps the first assembly, wherein the second front gap of the second assembly overlaps the first rear gap of the first assembly, forming a continuous vent between the first assembly and the second assembly.

### BRIEF DESCRIPTION

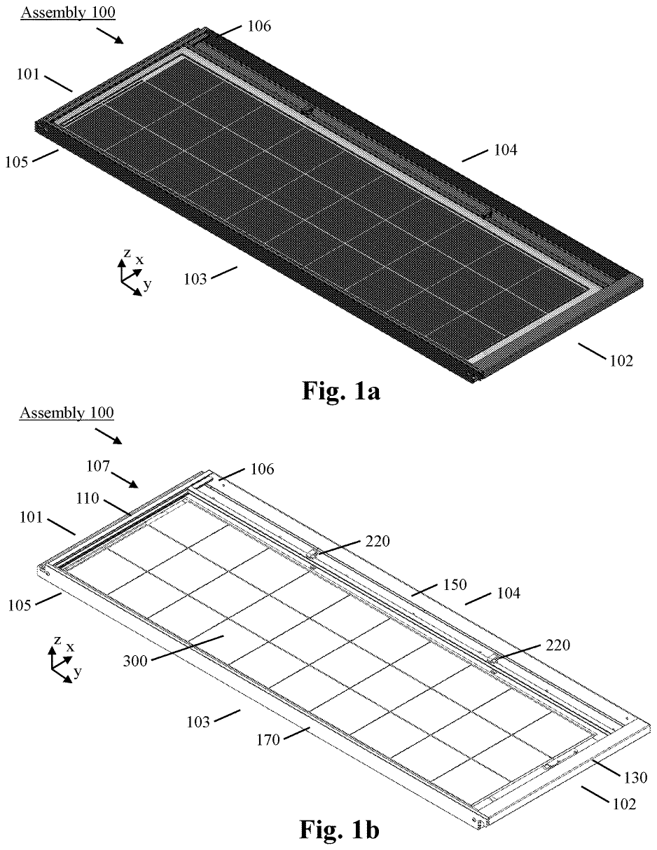

FIG. 1a shows an isometric view of a modular building-integrated photo-voltaic (BIPV) solar assembly according to various example embodiments in a fully assembled state.

FIG. 1b shows an isometric wireframe view of the solar assembly of FIG. 1a.

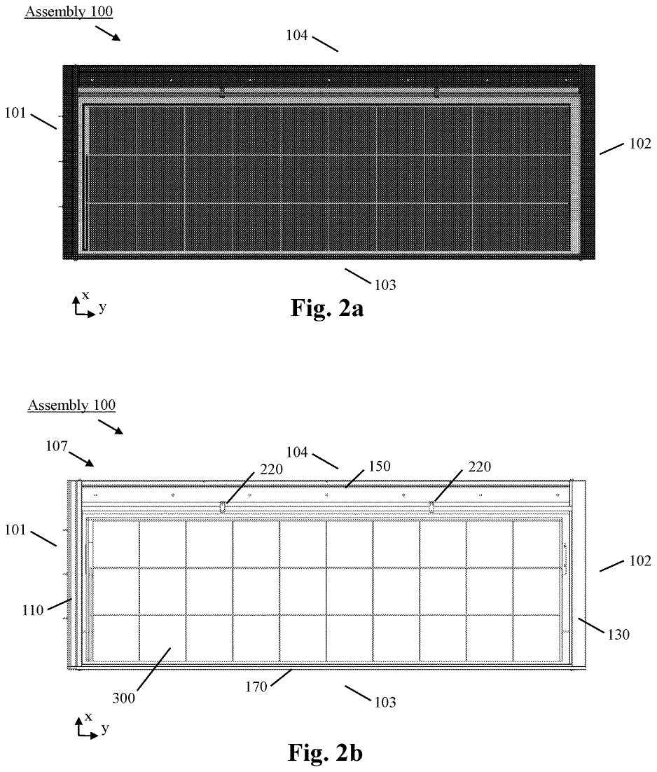

FIG. 2a shows a top view of the modular solar assembly in the fully assembled state.

FIG. 2b shows a wireframe top view of the solar assembly of FIG. 2a.

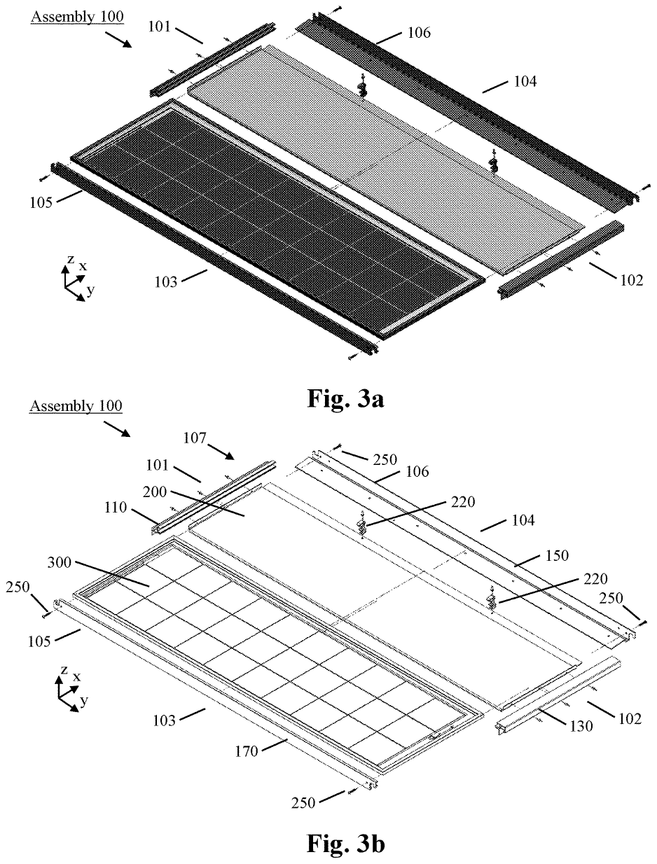

FIG. 3a shows an isometric exploded view of the modular solar assembly.

FIG. 3b shows an isometric exploded wireframe view of the solar assembly of FIG. 3a.

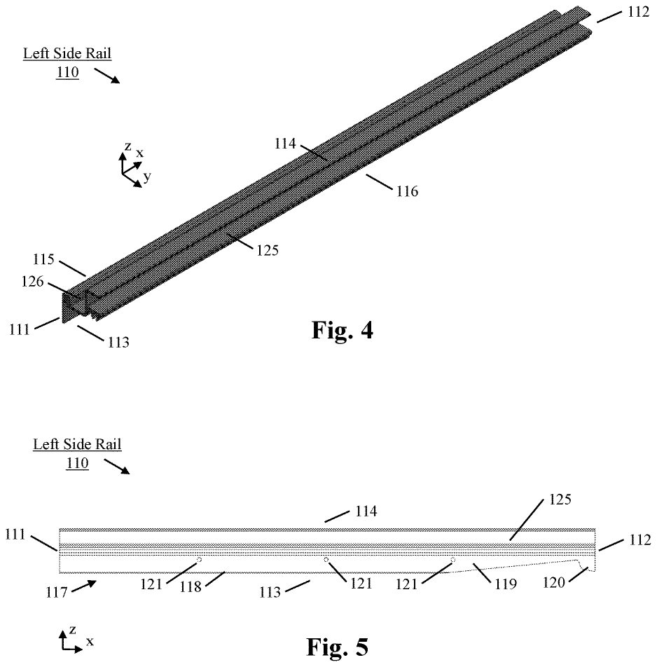

FIG. 4 shows a perspective view of a left side rail of a frame sub-assembly according to various exemplary embodiments.

FIG. 5 shows a side wireframe profile view of the left side rail of FIG. 4.

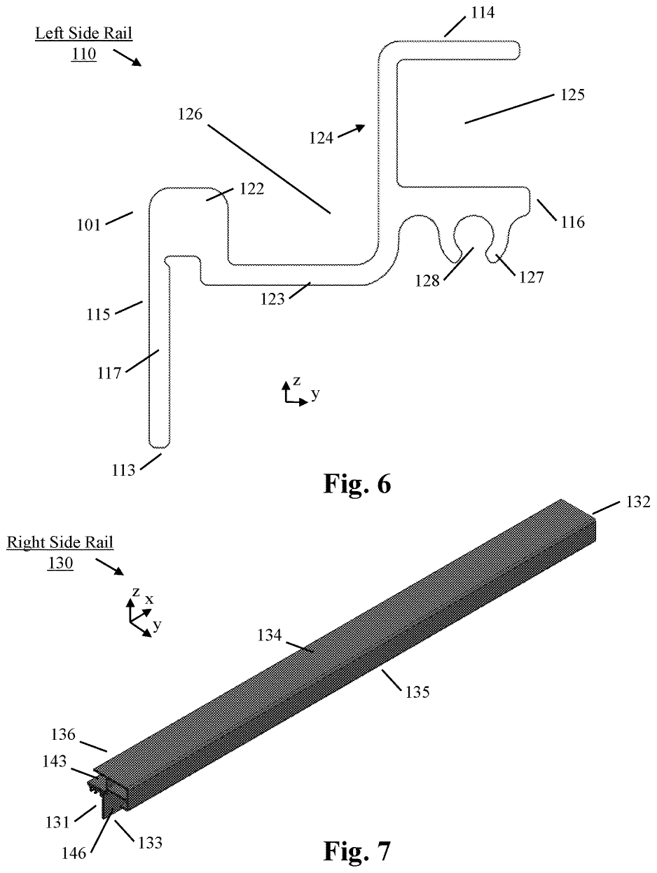

FIG. 6 shows a front wireframe profile view of the left side rail of FIG. 4.

FIG. 7 shows an isometric view of a right side rail of the frame sub-assembly according to various exemplary embodiments.

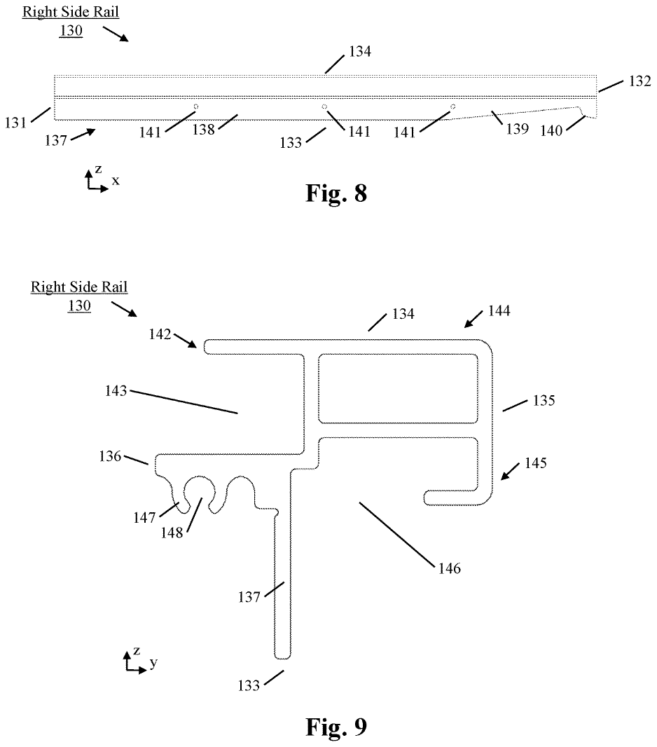

FIG. 8 shows a side wireframe profile view of the right side rail of FIG. 6.

FIG. 9 shows a front wireframe profile view of the right side rail of FIG. 6.

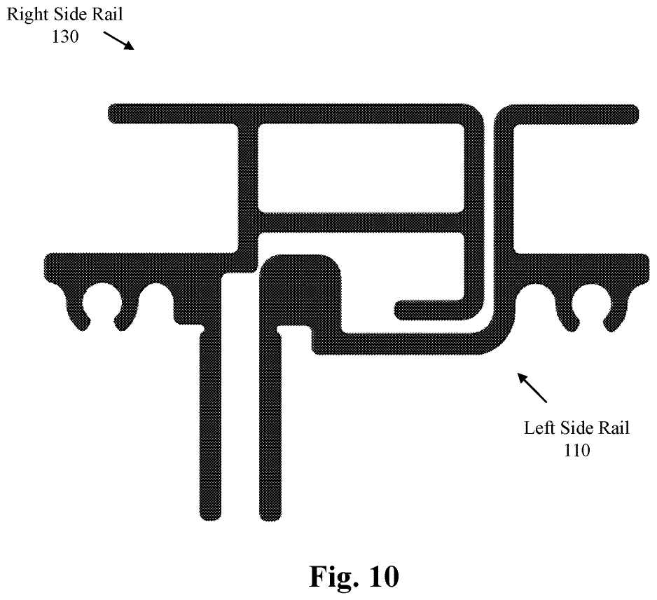

FIG. 10 shows the right side rail of a first solar assembly adjacent to a left side rail of a second solar assembly according to one example.

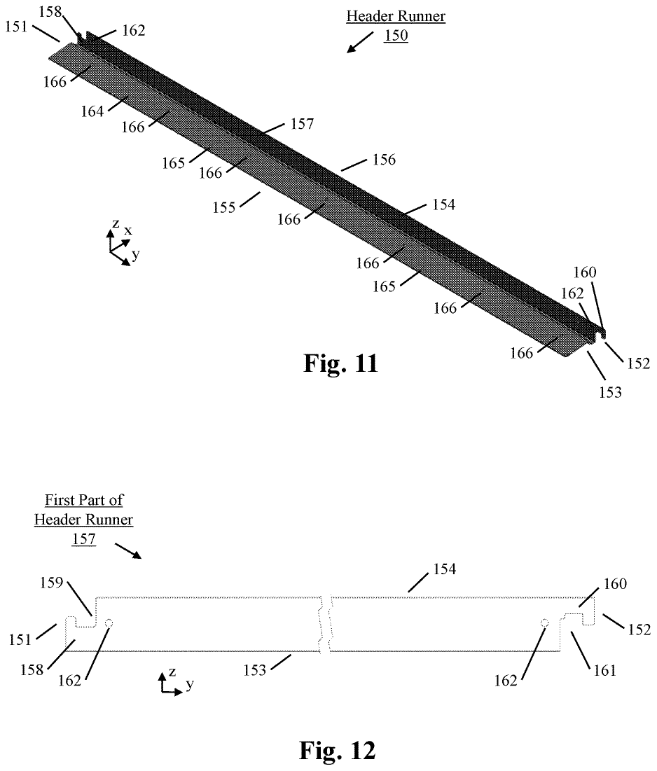

FIG. 11 shows an isometric view of a header runner of the frame sub-assembly according to various exemplary embodiments.

FIG. 12 shows a front view of a first part of the header runner of FIG. 11.

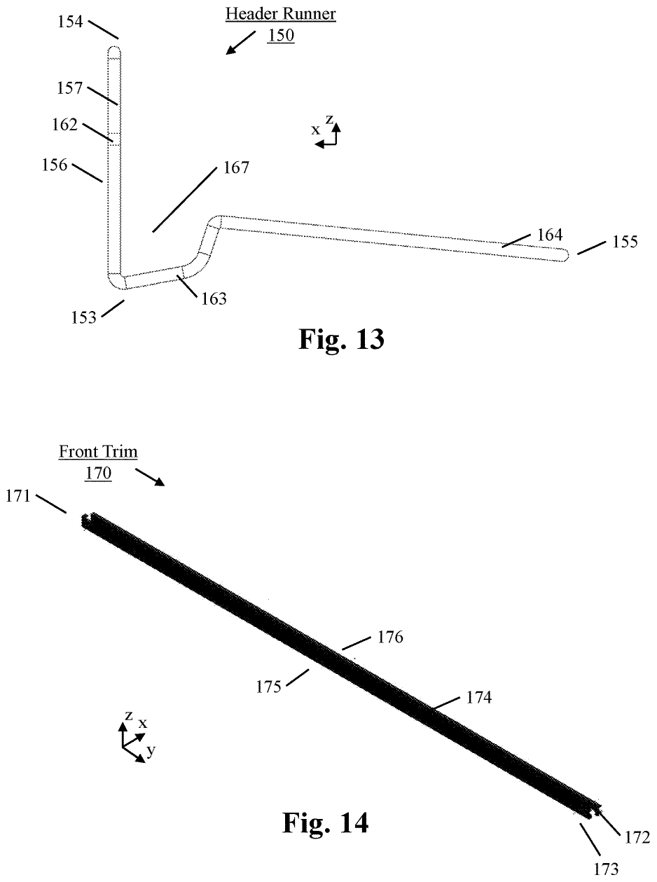

FIG. 13 shows a wireframe profile side view of the header runner of FIG. 11.

FIG. 14 shows an isometric view of a front trim of the frame sub-assembly according to various exemplary embodiments.

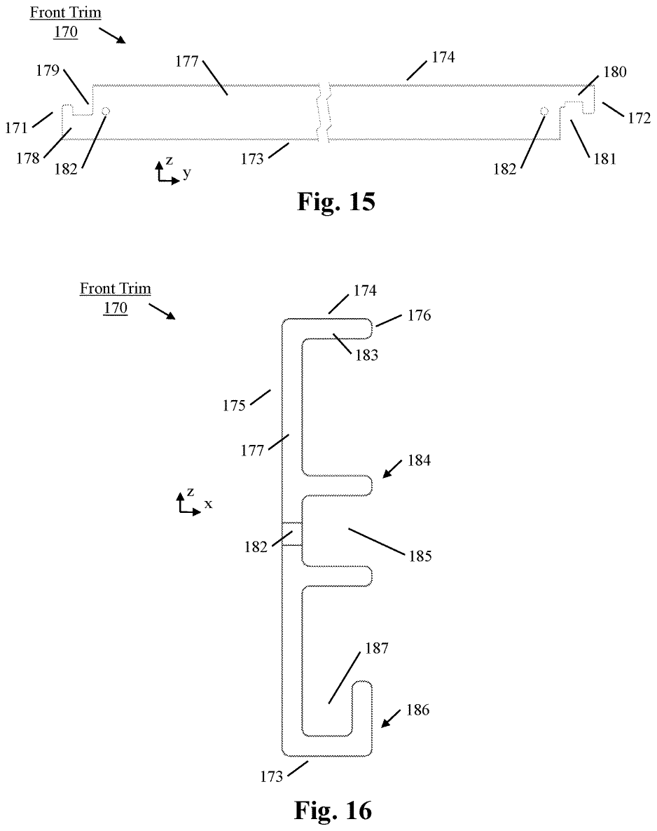

FIG. 15 shows a front wireframe break view of the front trim of FIG. 14.

FIG. 16 shows a side wireframe profile view of the front trim of FIG. 14.

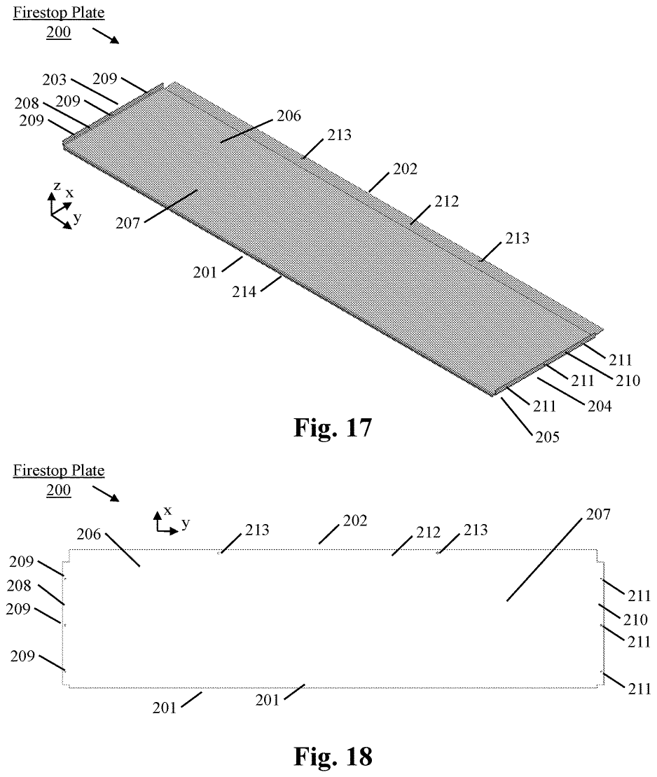

FIG. 17 shows an isometric view of a firestop plate of the solar assembly according to various exemplary embodiments.

FIG. 18 shows a top wireframe view of the firestop plate of FIG. 17 in an as-cut state prior to bending or pressing the sides of the firestop plate.

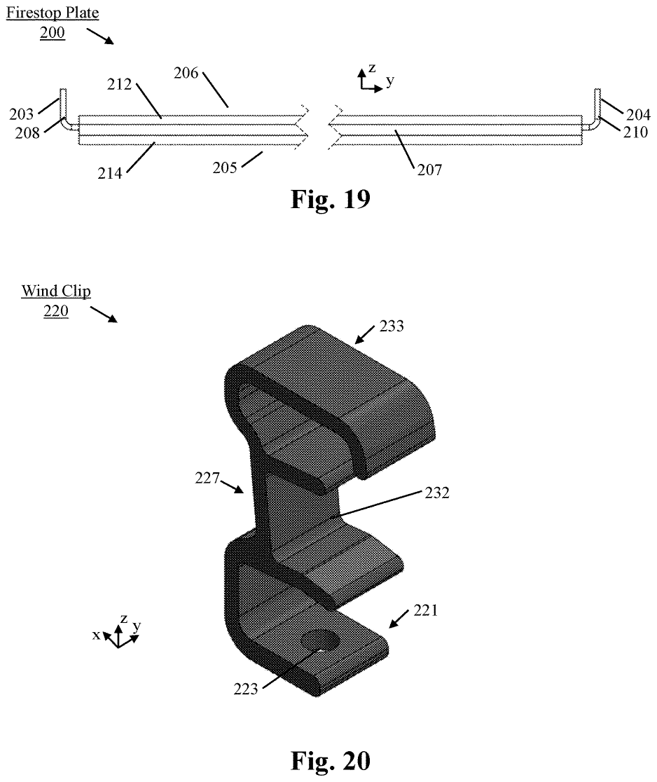

FIG. 19 shows a front wireframe break view of the firestop plate of FIG. 17 after bending or pressing the sides of the firestop plate.

FIG. 20 shows an isometric view of a wind clip of the solar assembly according to various exemplary embodiments.

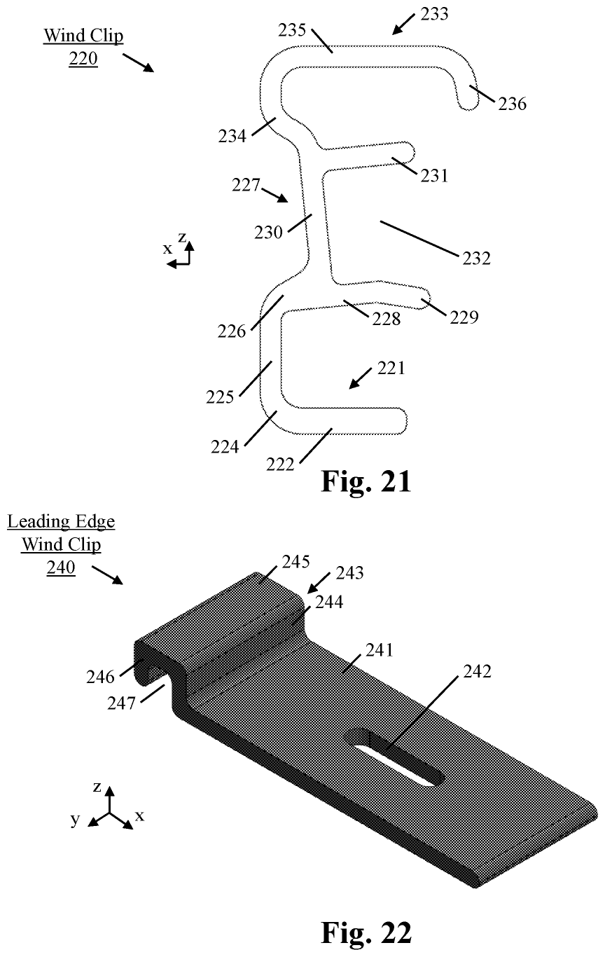

FIG. 21 shows a side wireframe profile view of the wind clip of FIG. 20.

FIG. 22 shows an isometric view of a leading edge wind clip of the solar assembly according to various exemplary embodiments.

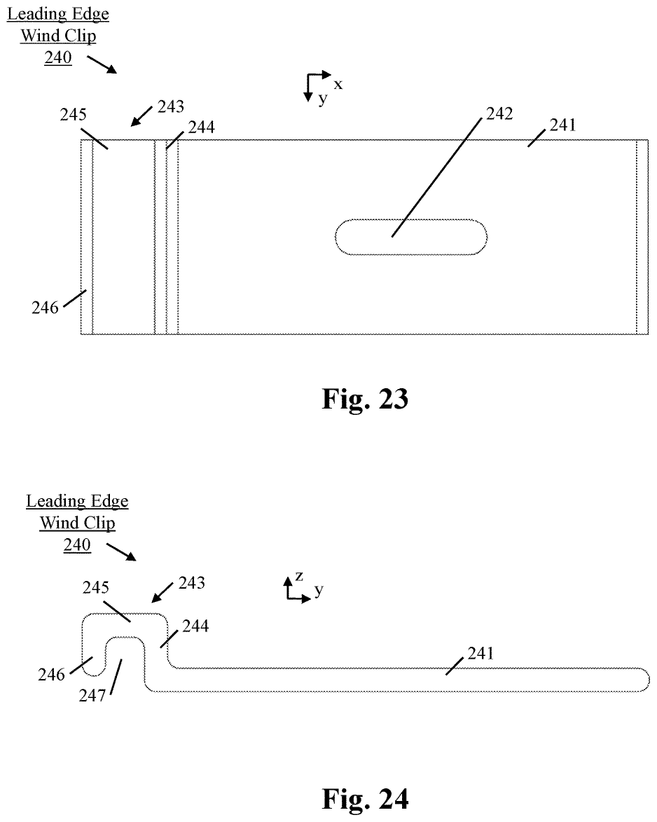

FIG. 23 shows a top wireframe view of the leading edge wind clip of FIG. 22.

FIG. 24 shows a side wireframe profile view of the leading edge wind clip of FIG. 22.

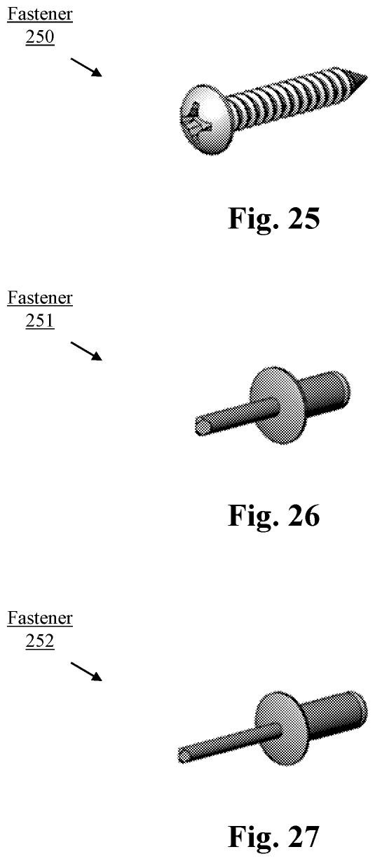

FIG. 25 shows a first fastener of the solar assembly.

FIG. 26 shows a second fastener of the solar assembly.

FIG. 27 shows a third fastener of the solar assembly.

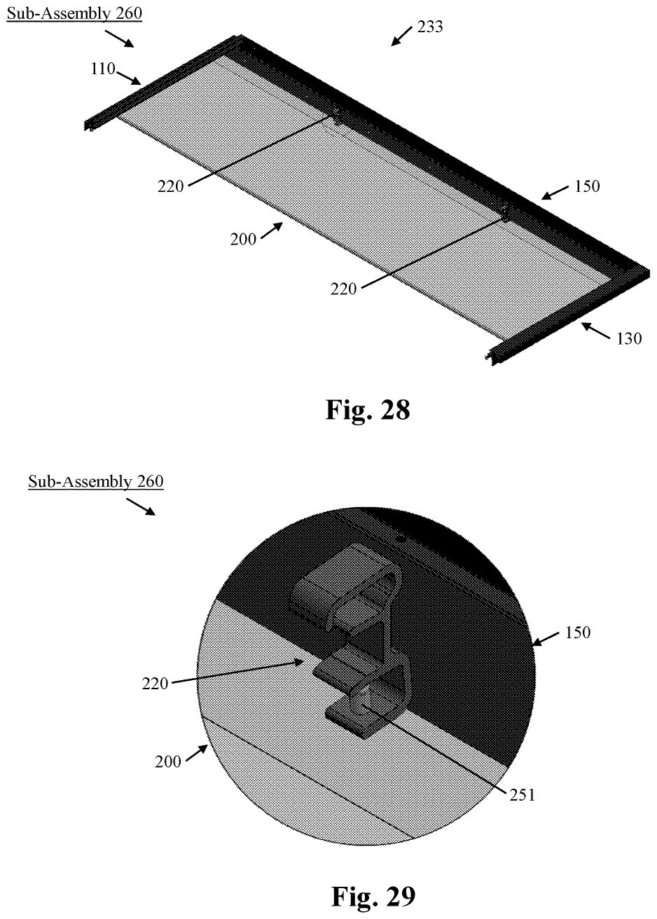

FIG. 28 shows an isometric view of a sub-assembly of the solar assembly according to various exemplary embodiments.

FIG. 29 shows an isometric view of the wind clip of the sub-assembly of FIG. 28.

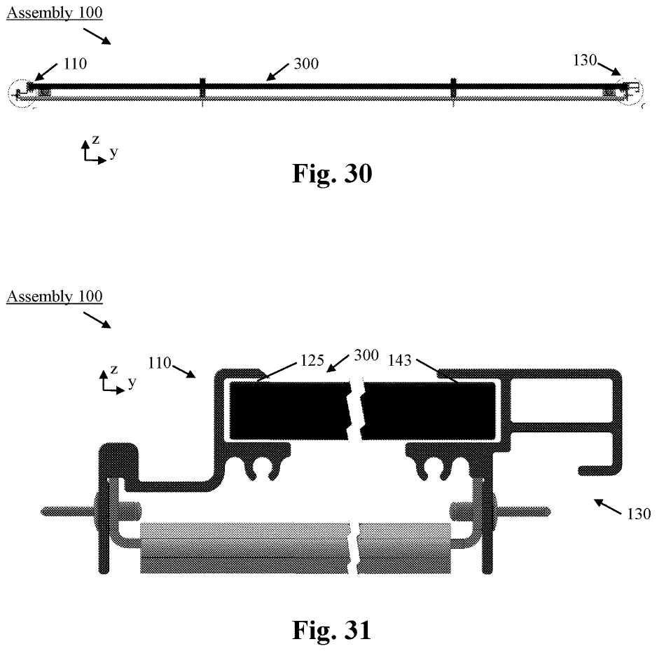

FIG. 30 shows a front profile of the solar assembly in a partially assembled state according to various exemplary embodiments.

FIG. 31 shows a magnified front break view of the solar assembly of FIG. 30 with the laminate received in the slots of the left and right side rails.

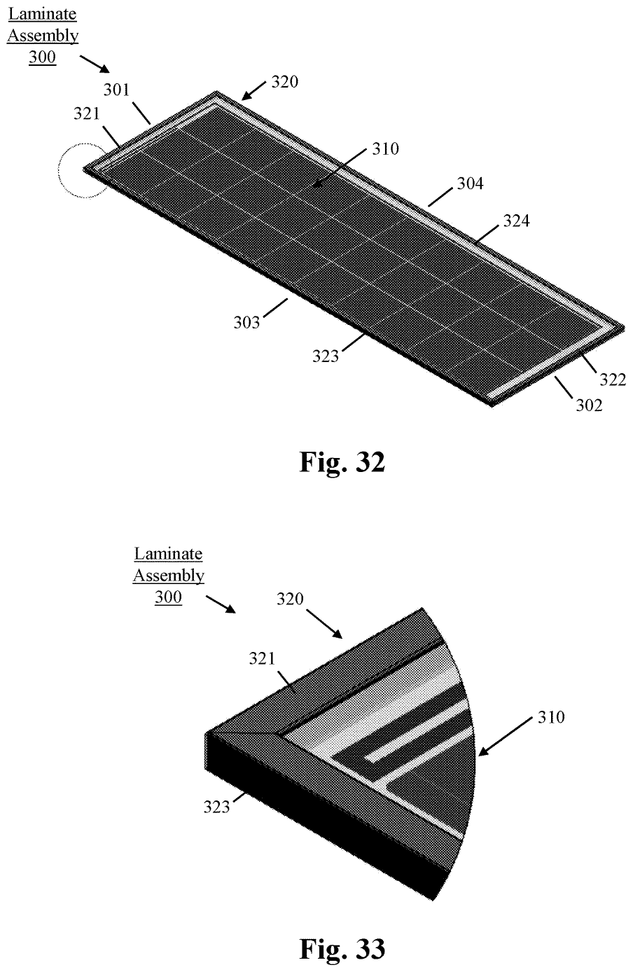

FIG. 32 shows an isometric view of a laminate assembly of the solar assembly according to various exemplary embodiments.

FIG. 33 shows a magnified detail view of the laminate assembly of FIG. 32 showing the solar laminate within a laminate edge protector.

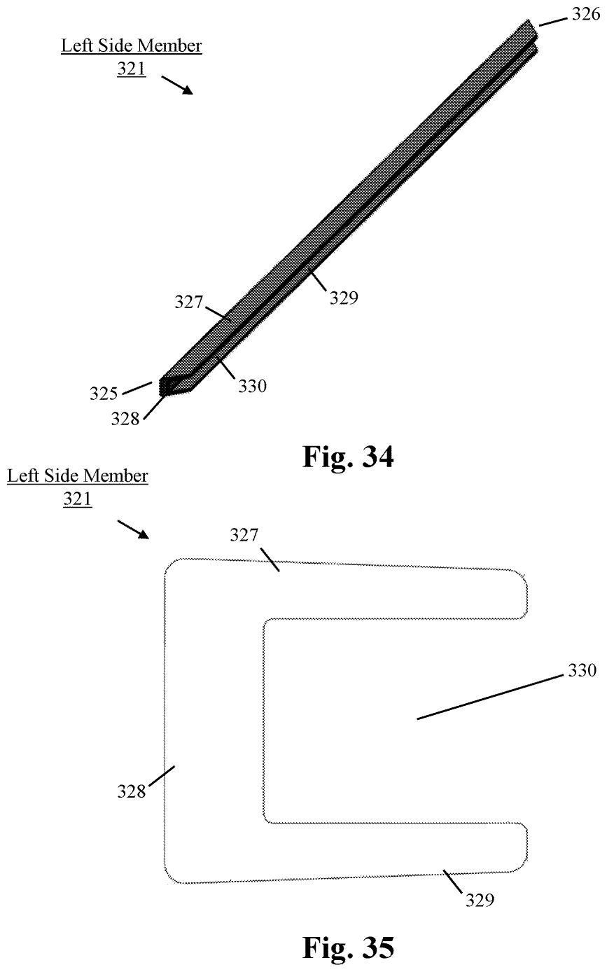

FIG. 34 shows an isometric view of a side member of the laminate edge protector according to various exemplary embodiments.

FIG. 35 shows a side wireframe profile view of the side member of the laminate edge protector of FIG. 34.

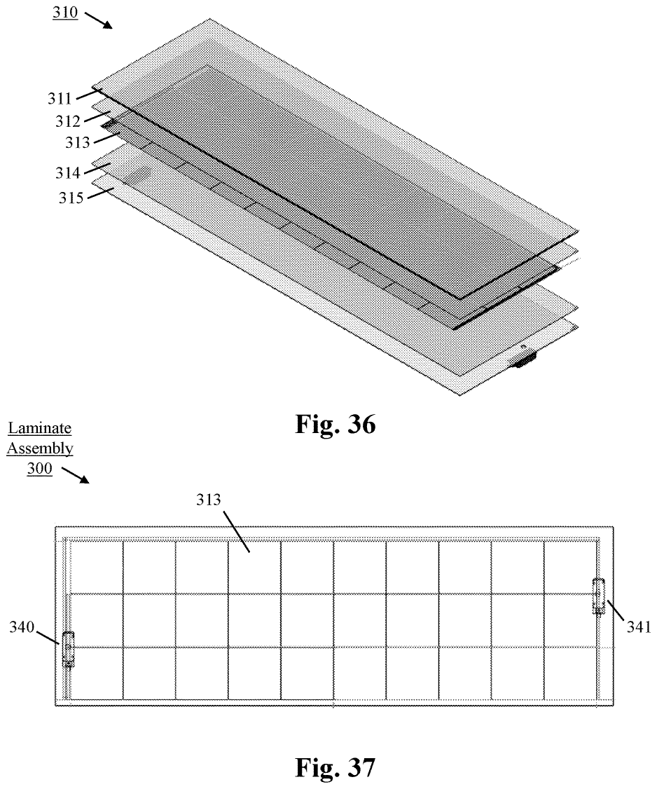

FIG. 36 shows an isometric exploded view of a laminate of the solar assembly according to various exemplary embodiments.

FIG. 37 shows a top wireframe view of the laminate assembly including a solar cell and a split junction box.

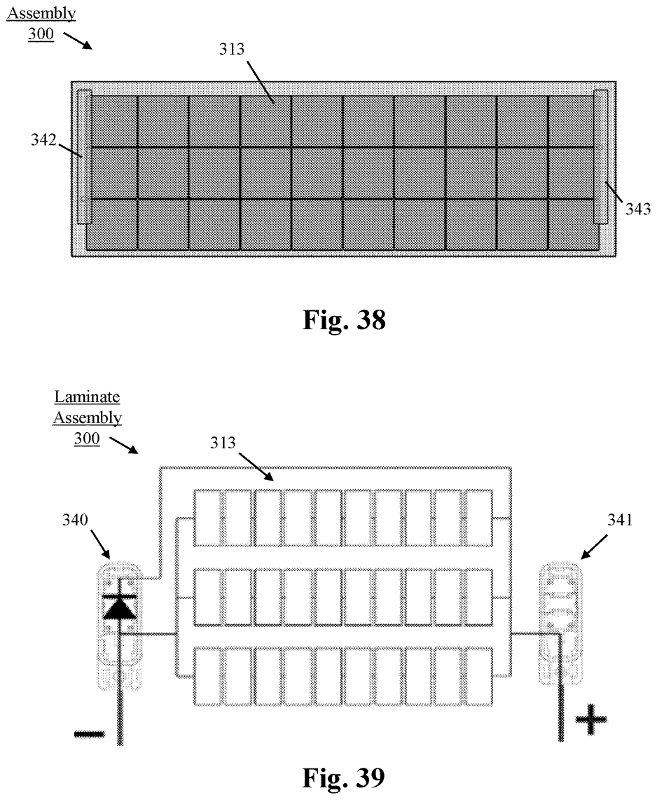

FIG. 38 shows a second top view of the laminate assembly including a solar cell and acceptable junction box regions.

FIG. 39 shows a circuit diagram of the solar cell of the laminate assembly.

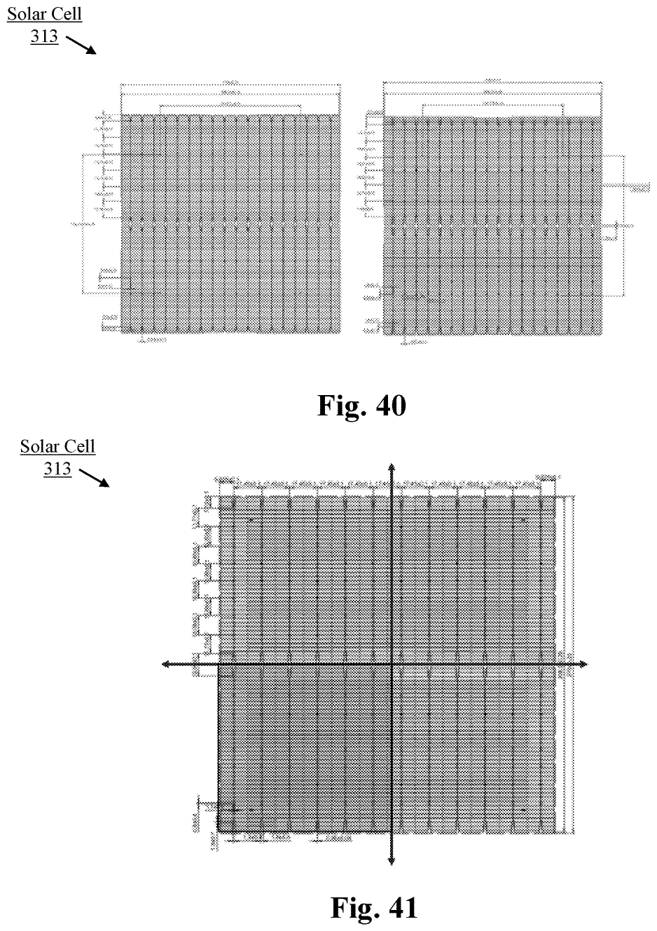

FIG. 40 shows a front side and a back side of the solar cell of the laminate assembly.

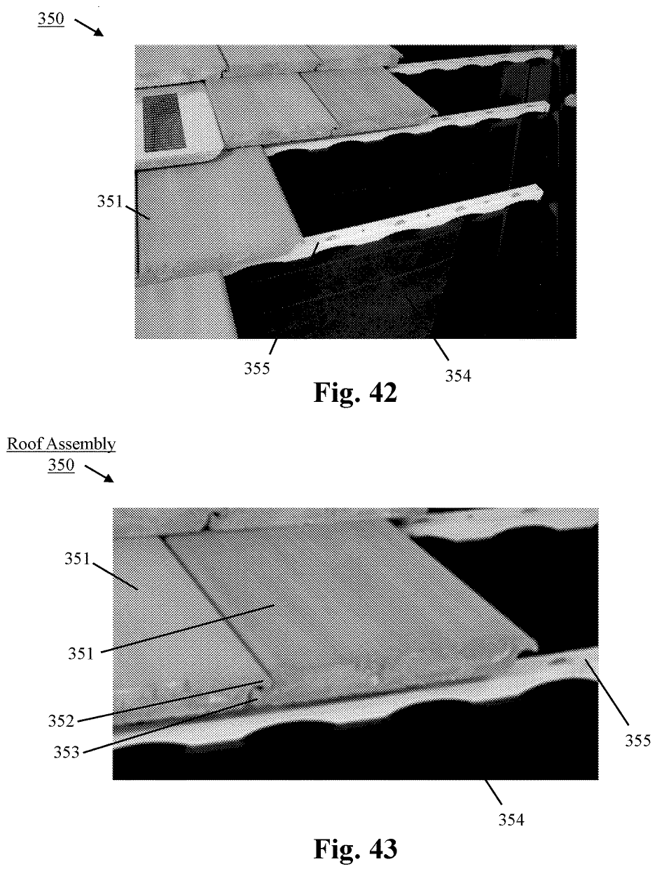

FIG. 41 shows a cell cut design of the solar cell of the laminate assembly.

FIG. 42 shows roof tiles installed on horizontal roof support members according to one example.

FIG. 43 shows a magnified view of the roof tiles of FIG. 42.

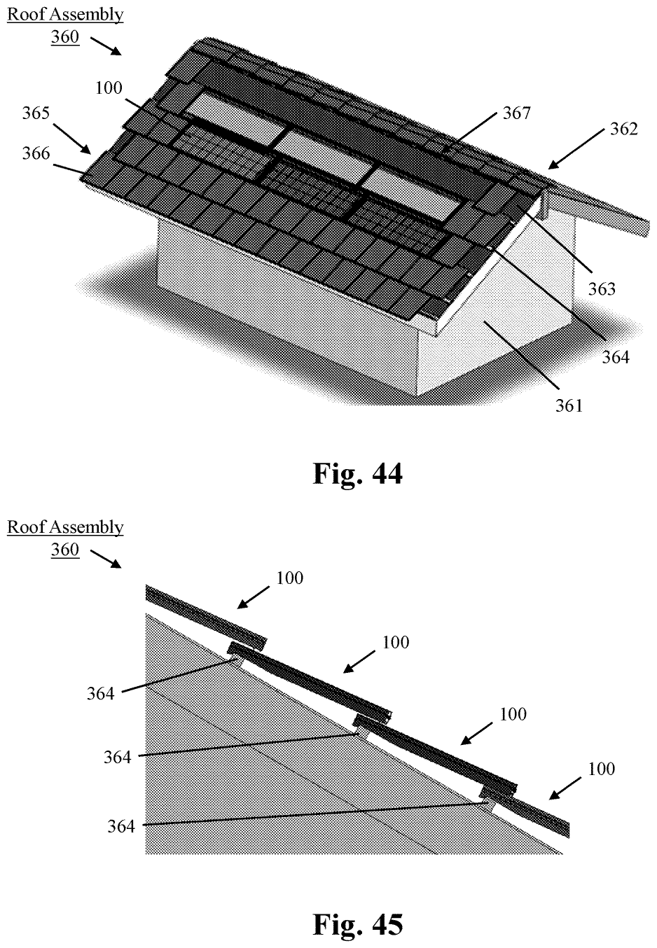

FIG. 44 shows a roof assembly including multiple solar assemblies according to various exemplary embodiments.

FIG. 45 shows a side view of the roof assembly of FIG. 44.

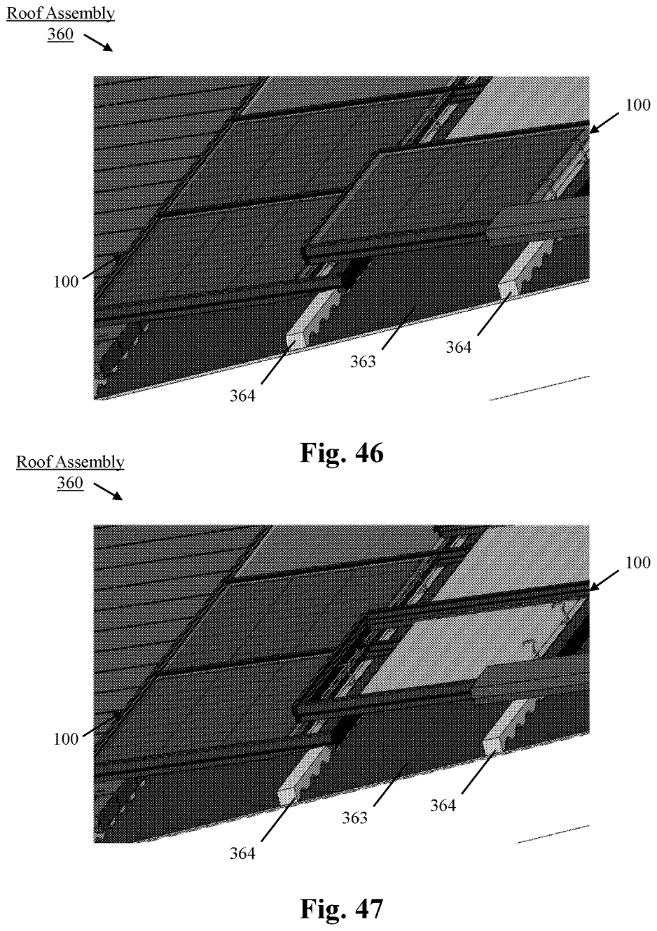

FIG. 46 shows an isometric view of the roof assembly of FIG. 44.

FIG. 47 shows the view of FIG. 46 with a laminate removed from a frame.

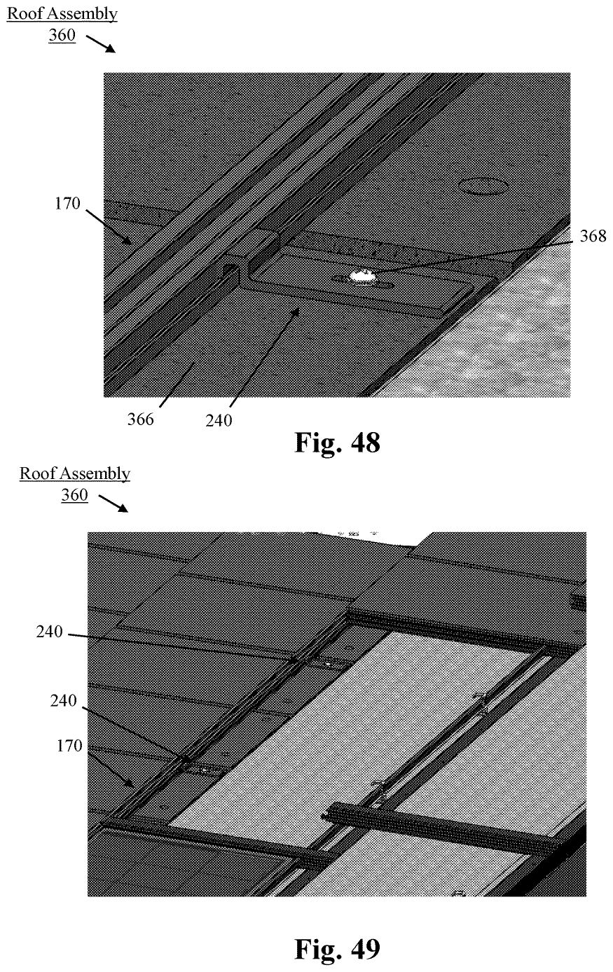

FIG. 48 shows a view of the roof assembly including a leading edge wind clip coupled to the front trim of the solar assembly and fastened to a lower roof tile according to various exemplary embodiments.

FIG. 49 shows a view of the roof assembly including multiple leading edge wind clips coupled to the front trim of the solar assembly and fastened to a respective lower roof tile.

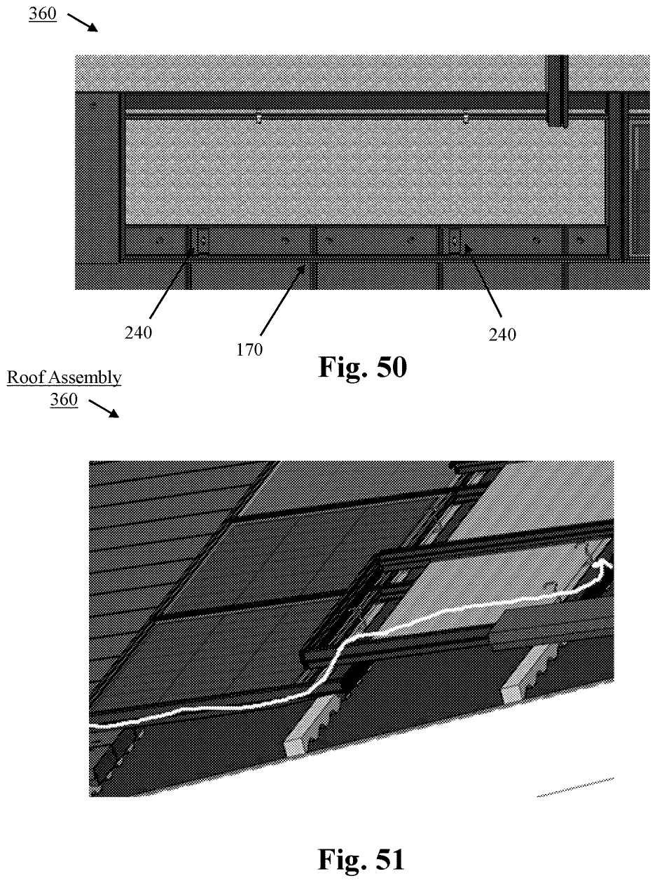

FIG. 50 shows a top view of the roof assembly of FIG. 49.

FIG. 51 shows the view of FIG. 47 with an illustration of airflow through adjacent solar assemblies.

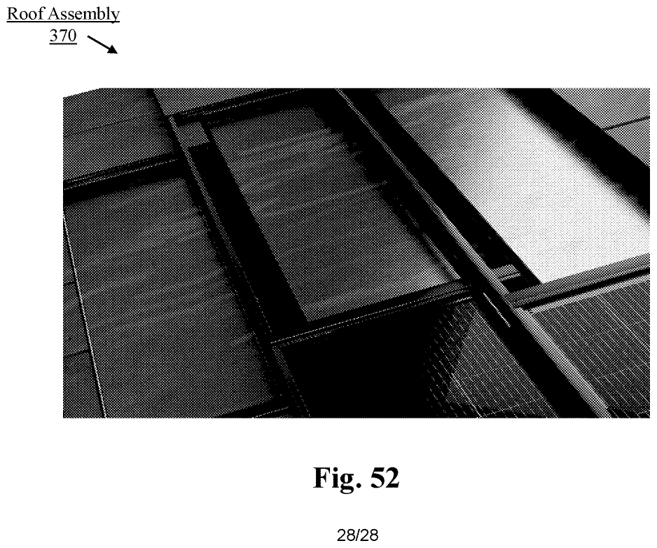

FIG. 52 shows a view of a further roof assembly with an illustration of airflow through adjacent solar assemblies.

### DETAILED DESCRIPTION

The exemplary embodiments describe may be further understood with reference to the following description and the related appended drawings, wherein like elements are provided with the same reference numerals. The exemplary embodiments are described with regard to solar panels and support structure thereof. The exemplary embodiments relate to a solar assembly designed for integration into a roof of a house, e.g., a building-integrated photovoltaic (BIPV) or roof-integrated photovoltaic (RIPV) assembly. The exemplary solar assembly includes a solar laminate comprising photovoltaic (PV) cells (i.e., solar cells) for converting sunlight into electricity. The exemplary solar assembly further includes a frame sized and shaped to have a footprint similar to a roof tile (e.g., a shingle) so that the assembly can be installed on a roof of a home in a space that would otherwise be occupied by such a roof tile.

In some embodiments, the solar assembly has a modular design. In some embodiments, a sub-assembly of the modular solar assembly, e.g., a first module including a majority of the frame and a firestop plate, can be installed on the roof in a first installation step and the solar components, e.g., a second module including the laminate and associated electronics, can be installed in a second installation step, enabling the decoupling the frame installation from the solar installation. The solar laminate can be easily inserted into or removed from the pre-installed frame, enabling straightforward installation, servicing, maintenance, and upgrades to the system. In some embodiments, the frame generally includes four components, e.g., a left side rail, a right side rail, a rear side header runner, and a front side trim, defining a substantially rectangular cross section of the assembly. In some embodiments, the sub-assembly (first module) can include the left side rail, the right side rail and the header runner of the frame, as well as a firestop plate and other components. The sub-assembly can be fastened to roof deck support structure (e.g., horizontal wooden battens), in particular, via the rear side header runner. The solar laminate can be slid into the sub-assembly via slots in the left and right side rails and the front side trim can be fastened to the front sides of the left and right side rails to enclose the laminate within the frame and fully assemble the modular solar assembly.

In further embodiments, the exemplary solar assembly includes a firestop plate positioned beneath the solar laminate designed to enable a class A fire rating for the assembly. The firestop plate can be fastened to the frame, in particular, as part of the sub-assembly described above, to be described in greater detail below. After the solar laminate is installed in the frame, the firestop plate is substantially parallel to and spaced apart from the solar laminate. In some embodiments, the space between the laminate and the firestop plate, in combination with a front opening to the space (between the front side of the firestop plate and the front side trim) and a rear opening to the space (between the rear side of the solar laminate and the rear side header runner), effectively forms a vent or channel permitting air to passively pass through the space to cool the solar laminate. In some cases, when multiple solar assemblies are arranged vertically on the roof, a continuous channel of cooling air is formed across the multiple solar assemblies.

In further embodiments, the exemplary solar assembly is designed so that multiple instances of the solar assembly can be installed on the roof, e.g., adjacent to one another horizontally across the roof and/or vertically along the pitch of the roof. It should be understood that any number of solar assemblies can be installed on a roof, limited only by the size of the roof. In general, any combination of solar assemblies and roof tiles can be installed for a given roof and, in some cases, a roof can be outfitted with only solar assemblies, e.g., to maximize the amount of electricity that can be generated via the roof. In some embodiments, a frame can be installed on the roof and a non-solar tile (e.g., a “blank”) can be inserted therein (e.g., temporarily) until the solar laminate is to be installed. In some cases, e.g., if it is desired for aesthetic purposes to provide a roof having a consistent visual appearance but it is not desired to outfit the entire roof with solar panels, the roof can be outfitted completely with frames with some of the frames having non-solar tiles installed therein permanently.

In still further embodiments, the exemplary solar assembly includes clips and fasteners for joining the various components of the assembly, e.g., the frame components, the firestop plate, etc. In some embodiments, a first wind clip (e.g., a rear side wind clip) is configured to be fastened to the rear side header runner and the firestop plate, the first wind clip including a slot for slidably receiving a rear side of the solar laminate. The wind clip functions as a receiver for stabilizing the rear side of the laminate and enables compliance with wind uplift standards and/or requirements set by industry and/or governmental entities. In some designs, two or more wind clips can be used for stabilizing the laminate. In some embodiments, a second wind clip (e.g., a leading edge wind clip) is configured to be coupled to the front side trim and fastened to an adjacent (lower) roof tile. In some designs, two or more leading edge wind clips can be used to stabilize the front end of the assembly. It should be understood that the leading edge wind clip is used only for a solar assembly that has a roof tile adjacent to its front side, e.g., for two solar assemblies arranged in vertical sequence, the upper solar assembly is not fastened to the lower solar assembly by a leading edge wind clip or any other fastening component.

Building-integrated photovoltaics (BIPV) (building-integrated solar) refers to solar panels or solar modules integrated into the structure of a building, e.g., a roof, a façade or a window. BIPVs can generate electricity while also providing building protection and aesthetic benefits, e.g., relative to some existing roof-mounted solar panels that are mounted on support structure (e.g., a “rack”) elevated above the roof. Rack-mounted solar panels can present several difficulties including, e.g., weakening the integrity of the roof by the additional weight of the panels and racking system in combination with roof penetrations required to attach the rack; panels detaching due to the exposure of the panels to wind forces; difficult and costly installation and maintenance; and/or an aesthetically displeasing appearance.

The present disclosure relates to a solar assembly designed for integration into a building, e.g., a BIPV. In particular, the exemplary solar assembly can be integrated into a roof of a house, e.g., a RIPV. It should be understood that the solar assembly is designed with certain characteristics (e.g., spatial dimensions, weight, durability, etc.) similar to or selected in dependence on corresponding characteristics of roof tiles (e.g., shingles) and for compatibility with such roof tiles. The exemplary solar assembly described herein can be designed in dependence on these dimensions so that the solar assembly can replace roof tiles, e.g., be inserted into a space that would ordinarily be occupied by roof tiles.

Those skilled in the art understand that roof tiles (e.g., shingles) are commonly installed on pitched roofs. A given home can include a roof structure that includes multiple roof planes, otherwise referred to as slopes, faces, pitches, etc. In general, roof tiles are installed on a pitched roof as multiple horizontal rows arranged in a cascading manner (vertically along the pitch), e.g., a first roof tile positioned above a second roof tile has a lower end that rests on the upper end of the second roof tile.

Those skilled in the art understand that existing roof tiles are manufactured in various sizes and shapes and formed from various materials. For example, some roof tiles may be formed from concrete, while other roof tiles may be formed from asphalt. Concrete roof tiles are generally significantly larger and heavier than asphalt roof tiles. Further, different roofing companies can manufacture roof tiles of the same material (e.g., concrete) to have different dimensions.

In some embodiments, the exemplary solar assembly is designed (e.g., sized and shaped) for compatibility with and in dependence on characteristics of concrete roof tiles having specific dimensions and characteristics. In one illustrative example, the solar assembly is designed with a size corresponding to four concrete roof tiles of predefined dimensions, e.g., four adjacent concrete roof tiles in sequence horizontally. However, those skilled in the art understand that this size is not required, and the design of the exemplary solar assembly can be modified according to different goals. For example, the solar assembly can be designed to replace a different number of concrete roof tiles (e.g., 1, 2, 3, or greater than 4). In another example, the solar assembly can be designed to replace concrete roof tiles of different predefined dimensions (e.g., larger or smaller). In some embodiments, the left side of a first solar assembly (e.g., the left side of the left side rail) is shaped for compatibility with the right side of a second solar assembly (e.g., the right side of the right side rail), e.g., in the scenario where multiple solar assemblies are installed next to one another, or with the right side of a standard roof tile, e.g., in the scenario where a solar assembly is installed next to a roof tile. Similarly, the right side of a first solar assembly is shaped for compatibility with the left side of a second solar assembly or the left side of the standard roof tile. In particular, the solar assembly is shaped to have a tongue and groove profile similar to existing roof tiles, to be described in greater detail below.

In some embodiments, the exemplary solar assembly is further designed for compatibility with and in dependence on characteristics of roof structure typically used to support concrete roof tiles. In some embodiments, the exemplary solar assembly is compatible with roofs including a roof deck support structure comprising horizontal support members, e.g., wooden battens. In some embodiments, the wooden battens may comprise arched battens that permit ventilating airflow between the roof deck and the roof tiles, to be described in greater detail below. In some industry standard roof designs, only horizontal wooden battens are used atop the roof deck. Accordingly, in some embodiments, the exemplary solar assembly is designed to be fastened to such horizontal members, to be described in detail below.

It should be understood that, although the exemplary embodiments are described with regard to specific roof tiles (concrete, having certain dimensions, etc.) and types of roofs (sloped, incorporating horizontal wooden beam support structure, etc.), the present disclosure is not limited to these specific tile types and roof types. In various embodiments to be discussed in further detail below, modifications to the exemplary solar assembly are described for adapting the design of the solar assembly to different roof tile designs and/or different roof characteristics.

The exemplary solar assembly is described with regard to a front side, a back side, a left side, a right side, a bottom side, and a top side. These terms should be understood with regard to the roof plane on which the assembly is to be installed. The assembly is designed for installation on roofs that can include multiple roof planes, wherein the “front” of a given roof plane corresponds to the lower end of the roof plane which is, in many cases, adjacent to the side of the house (although this is not required). It should be understood that the exemplary solar assembly is described in the same orientation.

The exemplary solar assembly is described with regard to components having sides, ends, surfaces, etc. These terms should be understood in a flexible manner and can, in many cases, be used interchangeably. For example, a given “side” or “end” of the assembly or a component thereof may comprise a uniform two-dimensional surface, a non-uniform two-dimensional surface, an edge, etc. Accordingly, the term “side” or “end” should not necessarily be understood as referring to a uniform surface. It should be understood that this naming convention is used for ease of description to generally indicate an area of the solar assembly. Additionally, the exemplary solar assembly is described with regard to an x-axis or x-direction (generally corresponding to the direction from the front to the back of the solar assembly), a y-axis or y-direction (generally corresponding to the direction from the left to the right of the solar assembly), and a z-axis or z-direction (generally corresponding to the direction from the bottom side to the top side of the solar assembly). Various views of the solar assembly provided in the Figures include axes indicators for indicating these directions and were included for ease of description. In some cases, the sides of the solar assembly may be understood as orthogonal planes along these principle directions, e.g., a first xy-plane describes the bottom side of the assembly; a second xy-plane describes the top side of the assembly (the first xy-plane spaced apart from the second xy-plane); a first yz-plane describes the front side of the assembly; a second yz-plane describes the rear side of the assembly (the first yz-plane spaced apart from the second yz-plane); a first xz-plane describes the left side of the assembly; and a second xz-plane describes the right side of the assembly (the first xz-plane spaced apart from the second xz-plane).

This naming convention may be used to describe the assembly generally and/or particular components thereof. Additionally, the terms “length,” “width,” and “depth” may be used for describing the shapes of various components. These terms may be used locally for each component and are generally not consistent across every component. For example, a “width” of the left side rail refers to a distance in the y-direction, while a “width” of the rear side header runner refers to a distance in the x-direction. Additionally, the terms “up,” “down,” “left,” “right,” “forward,” and “backward” should be understood according to their common usage within the top, bottom, left, right, front, back framework used herein.

FIGS. 1a-b, 2a-b, and 3a-b show views of a solar assembly 100 according to various exemplary embodiments. The solar assembly 100 is described with regard to a first side 101 (left side 101), a second side 102 (right side 102), a third side 103 (front side 103), a fourth side 104 (rear side 104), a fifth side 105 (bottom side 105) and a sixth side 106 (top side 106), as shown in FIGS. 1a, 2a and 3a. FIGS. 1b, 2b and 3b show wireframe views of the solar assembly 100.

The solar assembly 100 includes a frame 107. The frame 107 includes a first member 110 (a left side member 110 or a left side rail 110) generally extending in the x-direction; a second member 130 (a right side member 130 or a right side rail 130) generally extending in the x-direction; a third member 150 (a rear member 150 or a rear header runner 150) generally extending in the y-direction; and a fourth member 170 (a front member 170 or front trim 170) extending in the y-direction. The four members 110, 130, 150, 170 of the frame 107 define a substantially rectangular cross section in the xy-plane, as shown in the top views of FIGS. 2a-b.

The frame members 110, 130, 150, 170 each comprise longitudinal members shaped with a cross-sectional profile designed to achieve various design goals. The shaped profiles can be formed by manufacturing processes including, e.g., extrusion. In some embodiments, the frame members 110, 130, 150, 170 are formed by aluminum extrusion. Aluminum may be a suitable material for the frame 107 due to its cost-effectiveness, light weight, strength, corrosion resistance and machinability. The members 110, 130, 150, 170 of the frame 107 can be assembled by fasteners 250, e.g., screws, as shown in the exploded views of FIGS. 3a-b and further below in FIG. 25. The fasteners 250 may be formed from a material compatible with the frame 107, e.g., aluminum. In other embodiments, the frame members 110, 130, 150, 170 can be formed from a different material such as, e.g., steel. In this case, the fasteners 250 may be formed from steel or another material compatible with a steel frame. In some cases, the fasteners may be coated with a material to prevent galvanic corrosion, e.g., in coastal areas with sea salt spray and/or in regions with high humidity.

FIGS. 4-6 show views of a left side rail 110 of the solar assembly 100 according to various exemplary embodiments. The left side rail 110 is described with regard to a first side 111 (front side 111 or front surface 111), a second side 112 (rear side 112 or rear surface 112), a third side 113 (bottom side 113), a fourth side 114 (top side 114 or top surface 114), a fifth side 115 (left side 115 or left surface 115) and a sixth side 116 (right side 116). In this example, relative to the xyz axes introduced above for the assembly 100, a length of the left side rail 110 (or a part thereof) refers to a distance in the x-direction; a width of the left side rail 110 (or a part thereof) refers to a distance in the y-direction, and a depth of the left side rail 110 (or a part thereof) refers to a distance in the z-direction.

The left side rail 110 comprises a longitudinal member with an extruded profile that defines a slot 125 (left side slot 125) extending along its length. The slot 125 is open on one side, facing (in the y-direction) toward the right side 102 of the assembly 100. The slot 125 is sized and shaped to slidably receive a left side 301 of the solar laminate assembly 300 therein, to be described in greater detail below. The extruded profile of the left side rail 110 further defines a groove 126 (slot or defined space) open to the left side 101 of the assembly, as shown in FIG. 6. The groove 126 is sized and shaped to receive therein a correspondingly shaped feature, e.g., a projection or a tongue, of either a further solar assembly (e.g., the right side thereof) or a standard roof tile to loosely couple the assembly to the further assembly or the standard roof tile, to be described in greater detail below. Additionally, the left side rail 110 includes features for fastening the left side rail 110 to further components of the assembly 100, in particular, holes 121 for fastening the left side rail 110 to the firestop plate 200 and holes 128 for fastening the left side rail 110 to the front side trim 170 and the rear side header runner 150.

The left side rail 110 extends longitudinally (x-direction) from the front side 111 to the rear side 112. The front side 111 is configured to be fastened to the front trim 170 and the rear side 112 is configured to be fastened to the header runner 150. The first side 111 and the second side 112 comprise flat surfaces. The left side rail 110 is described with regard to a first part 117, a second part 122, a third part 123, a fourth part 124 and a fifth part 127, each part extending longitudinally from the first side 111 to the second side 112. A profile (e.g., a transverse cross-section) of the left side rail 110, as shown in the front view of FIG. 6, is uniform throughout the length of the second part 122, the third part 123, the fourth part 124 and the fifth part 127. The first part 117 has a variable depth. It should be understood that the parts of the left side rail 110 are loosely defined and are named as such only for ease of description. It should be understood that the left side rail 110 comprises a single extruded (unitary) piece. In alternative examples, a first part of the left side rail 110 can comprise the left side shape defining the groove 126 and a second part of the left side rail 110 can comprise the right side shape defining the slot 125. It should be understood that the parts of the left side rail 110 and other components described in a similar manner can be delineated in various ways.

Considered in the yz-plane, the first part 117 of the left side rail 110 extends from the bottom side 113 toward the top side 114 and defines the left side 115 of the left side rail 110. The second part 122 of the left side rail 110 extends off the top of the first part 117 and comprises a solid cross section having a rounded top, generally extending from the left side 115 toward the right side 116. The third part 123 of the left side rail 110 extends off the bottom of the second part 122 toward the right side 116, curving up on its right end. The fourth part 124 of the left side rail 110 comprises a first portion that extends off the top of the third part 123 toward the top side 114 (a bottom portion), a second portion extending off the top of the first portion toward the right side 116 (a vertical portion), and a third portion extending off the bottom of the first portion toward the right side 116 (a top portion). The first, second and third portions of the fourth part 124 form a C-shape that defines the slot 125. Additionally, a right side of the second part 122, a top side of the third part 123, and a left side of the fourth part 124 define the groove 126.

As shown in the side view of FIG. 5, the first part 117 of the left side rail 110 has a variable depth (z-direction). A first portion 118 of the first part 117 has a uniform depth, defines the bottom side 113 of the left side rail 110 and extends from the front end 111 toward the back end 112; a second portion 119 of the first part 117 extends at an angle, e.g., 10 degrees relative to the xy-plane, from the back of the first portion 118 toward the back side 112 and the top side 114, e.g., reduces in depth; and a third portion 116 extends at a first angle, e.g., close to 90 degrees relative to the xy-plane, then curves into a second angle, e.g., 10 degrees relative to the xy-plane, toward the bottom side 113 and the back end 112. The shape of the second portion 119 and the third portion 120 is designed for compatibility with the rear side header runner 150. In particular, the angle of the second portion 119 corresponds to an angle of a third part 164 (e.g., front part) of the rear side header runner 150 and the shape of the third portion 120 comprises a feature or projection that can be received in a space 167 (e.g., groove) of the rear side header runner 150 to loosely couple the left side rail 110 and the rear side header runner 150 prior to fastening these components, to be described in greater detail below.

Additionally, the first part 117 of the left side rail 110 includes multiple holes 121 cut or punched along its length for fastening the firestop plate 200 to the left side rail 110, e.g., by the fastener 252 of FIG. 27. The fifth part 127 of the left side rail 110, as shown in FIG. 6, extends off a bottom of the fourth part 124 (the part defining the slot 125) and defines a hole 128 at the front end 111 of the left side rail 110 for fastening the front side trim 170 to the left side rail 110 and a hole 128 at the rear end 112 of the left side rail 110 for fastening the rear side header runner 150 to the left side rail 110.

FIGS. 7-9 show views of a right side rail 130 of the solar assembly 100 according to various exemplary embodiments. The right side rail 130 is described with regard to a first side 131 (front side 131 or front surface 131), a second side 132 (rear side 132 or rear surface 132), a third side 133 (bottom side 133), a fourth side 134 (top side 134 or top surface 134), a fifth side 135 (right side 135 or right surface 135) and a sixth side 136 (left side 136). In this example, a length of the right side rail 130 (or a part thereof) refers to a distance in the x-direction; a width of the right side rail 130 (or a part thereof) refers to a distance in the y-direction, and a depth of the right side rail 130 (or a part thereof) refers to a distance in the z-direction.

The right side rail 130 comprises a longitudinal member with an extruded profile that defines a slot 143 (right side slot 143) extending along its length. The slot 143 is open on one side, facing (in the y-direction) toward the left side 101 of the assembly 100. The slot 143 is sized and shaped to slidably receive a right side 302 of the solar laminate assembly 300 therein, to be described in greater detail below. The extruded profile of the right side rail 130 further defines a feature or a projection that extends downward on the right side 135, e.g., a tongue, as shown in FIG. 9. This feature is sized and shaped to be received within a correspondingly shaped feature, e.g., a groove or a space, of either a further solar assembly (e.g., the left side thereof) or a standard roof tile, to be described in greater detail below. Additionally, the right side rail 130 includes features for fastening the right side rail 130 to further components of the assembly 100, in particular, holes 141 for fastening the right side rail 130 to the firestop plate 200, a hole 148 at the front end 131 for fastening the right side rail 130 to the front side trim 170 and a hole 148 at the rear end 132 for fastening the right side rail 130 to the rear side header runner 150.

The right side rail 130 extends longitudinally (x-direction) from the front side 131 to the rear side 132. The front side 131 is configured to be fastened to the front trim 170 and the rear side 132 is configured to be fastened to the header runner 150. The first side 131 and the second side 132 comprise flat surfaces. The right side rail 130 is described with regard to a first part 137, a second part 142, a third part 144, a fourth part 145 and a fifth part 147, each part extending longitudinally from the first side 131 to the second side 132. A profile (e.g., a transverse cross-section) of the right side rail 130, as shown in the front view of FIG. 6, is uniform throughout the length of the second part 142, the third part 144, the fourth part 145 and the fifth part 147. The first part 137 has a variable depth. It should be understood that the parts of the right side rail 130 are loosely defined and are named as such only for ease of description, similar to the description of the left side rail 110.

Considered in the yz-plane, the first part 137 of the right side rail 130 extends from the bottom side 133 toward the top side 134. The top of the first part 137 may be reinforced with additional material to support the second part 142 The second part 142 of the right side rail 130 comprises a first portion that extends off the top of the first part 137 toward the left side 136 (a bottom portion), a second portion extending off the right side of the first portion toward the top side 134 (a vertical portion), and a third portion extending off the top of the second portion toward the left side 136 (a top portion). The first, second and third portions form a C-shape that defines the slot 143. The third part 144 of the right side rail 130 extends off the right side of the second part 142, generally comprising two horizontal portions (y-direction) and a vertical portion (z-direction) forming a box. The vertical portion of the third part 144 defines the right side 135 of the right side rail 130. The fourth part 145 of the right side rail 130 comprises a vertical portion extending toward the bottom side 133 off the right side of the third part 144, a curve, and a horizontal portion extending off the bottom of the vertical portion toward the left side 136. The fourth part 145 defines a projection, e.g., in a tongue shape. Additionally, a right side of the first part 137, a bottom-right corner of the second part 142, a bottom side of the third part 144, and the left side of the fourth part 145 define a space 146

As shown in the side view of FIG. 8, the first part 137 of the right side rail 130 has a variable depth (z-direction), similar to the first part 117 of the left side rail 110. A first portion 138 of the first part 137 has a uniform depth, defines the bottom side 133 of the right side rail 130 and extends from the front end 131 toward the back end 132; a second portion 139 of the first part 137 extends at an angle, e.g., 10 degrees relative to the xy-plane, from the back of the first portion 138 toward the back end 132 and the top side 134, e.g., reduces in depth; and a third portion 140 extends at a first angle, e.g., close to 90 degrees relative to the xy-plane, then curves into a second angle, e.g., 10 degrees relative to the xy-plane, toward the bottom side 133 and the back end 132. The shape of the second portion 139 and the third portion 140 of the first part 137 of the right side rail 130 is designed for compatibility with the rear side header runner 170, similar to the second portion 119 and the third portion 120 of the first part 117 of the left side rail 110 as described above.

Additionally, the first part 137 of the right side rail 130 includes multiple holes 141 cut or punched along its length for fastening the firestop plate 200 to the right side rail 130, e.g., by the fastener 252 of FIG. 27. The fifth part 147 of the right side rail 130 extends off the bottom of the second part 142 (defining the slot 143) and defines a hole 148 at the front end 131 of the right side rail 130 for fastening the front side trim 170 to the right side rail 130 and a hole 148 at the rear end 132 of the right side rail 130 for fastening the rear side header runner 150 to the right side rail 130.

Accordingly, as described above, the left side rail 110 and the right side rail 130 each include a respective slot extending along a length thereof for slidably receiving corresponding sides of the laminate 300 during installation thereof and for supporting the laminate 300 upon installation. Further, the left side rail 110 and the right side rail 130 each include holes cut or punched into the rails at multiple locations along the length thereof so that the firestop plate 200 can be riveted to the rails 110, 130. The left side rail 110 and the right side rail 130 further include holes at both ends thereof so that the rails 110, 130 can be fastened to the rear side header runner 150 and the front side trim 170. It is noted that the left side rail 110 and the right side rails 130 do not need to be fastened to the roof structure.

As described above, in some embodiments, the left side rail (e.g., of a first solar assembly) is shaped for compatibility with the right side rail (e.g., of a second solar assembly), e.g., in the scenario where multiple solar assemblies are installed next to one another, or with a right side of a standard roof tile, e.g., in the scenario where a solar assembly is installed next to a roof tile. Similarly, the right side of a first solar assembly is shaped for compatibility with the left side of a second solar assembly or the left side of the standard roof tile. The left side rail defines a groove (slot, channel or space) that matches the profile of a feature (projection or tongue) of the right side rail, similar to the tongue-and-groove profile of a standard roof tile.

FIG. 10 shows the right side rail 130 of a first solar assembly adjacent to a left side rail 110 of a second solar assembly according to one example. The frames of the first solar assembly and the second solar assembly are thereby brought into abutting contact and are loosely joined. The left side rail and the right side rail are designed to match the same tongue and groove profile of the concrete tiles, as shown below in FIGS. 42-43.

FIGS. 11-13 show views of a header runner 150 of the solar assembly 100 according to various example embodiments. The header runner 150 is described with regard to a first side 151 (left side 151 or left end 151), a second side 152 (right side 152 or right end 152), a third side 153 (bottom side 153 or bottom end 152), a fourth side 154 (top side 154 or top end 134), a fifth side 155 (front side 155 or front end 155) and a sixth side 156 (rear side 156 or rear surface 156). In this example, a length of the header runner 150 (or a part thereof) refers to a distance in the y-direction; a width of the header runner 150 (or a part thereof) refers to a distance in the x-direction, and a depth of the header runner 150 (or a part thereof) refers to a distance in the z-direction.

The header runner 150 comprises a longitudinal member with an extruded profile that defines a part 164 (otherwise referred to below as a third part 164 of the header runner 150) at the front thereof and extending along its length. The third part 164 extends toward the front side 103 of the assembly 100 and is sized and shaped so that a portion of the firestop plate 200 can overlap the third part 164, whereupon the firestop plate 200 and the third part 164 can be riveted together with the wind clip 220 through a hole in the wind clip 220, to be described in greater detail below. The extruded profile of the header runner 150 further includes a first part 157 (e.g., a vertical part at the rear 156 of the header runner 150) having a left end and a right end shaped with features for coupling to adjacent solar assemblies and/or roof tiles, e.g., a left side feature 158 defining a space 159 matching the space 126 defined by the left side rail 110 and a right side feature 160 defining a space 161 matching the space 146 defined by the right side rail 130, e.g., the tongue-and-groove profile described about. These features are sized and shaped to be received within a correspondingly shaped feature of either a further solar assembly or a standard roof tile. Additionally, the header runner 150 includes features for fastening the header runner 150 to further components of the assembly 100 and to roof structure, in particular, holes 162 for fastening the header runner 150 to the left side rail 110 and the right side rail 130, holes 165 for fastening the wind clip 220 to the third part 164 (and the firestop plate 200), and holes 166 for fastening the third part 164 to a horizontal wooden batten of the roof structure, to be described in greater detail below.

The header runner 150 extends longitudinally (y-direction) from the first side 151 to the second side 152. The header runner 150 is configured to be fastened to the left side rail 110 at a position adjacent to the first side 151 and to the right side rail 130 at a position adjacent to the second side 152. The header runner 150 is described with regard to a first part 157 (vertical part 157), a second part 163 (curved part 163), and a third part 164 (flap 164), each part extending longitudinally from the first side 151 to the second side 152. The first part 157 includes a feature on the left side 151 and a feature on the second side 152. The extruded profile (e.g., transverse cross-section) of the header runner 150, as shown in the side view of FIG. 13, is uniform throughout the length of the second part 163 and the third part 164.

The first part 157 of the header runner 150 extends vertically (z-direction) from the top side 154 to the bottom side 153 and defines the rear surface 156 of the header runner 150. The second part 163 of the header runner 150 comprises a first portion that extends at an angle, e.g., 10 degrees relative to the xy-plane, from the bottom of the first part 157 then curves into a second angle, e.g., 80 degrees relative to the xy-plane, toward the top side 154 and the front side 155. The third part 164 of the header runner 150 extends at an angle, e.g., 20 degrees relative to the xy-plane, off the front side of the second part 163 toward the front side 101 and bottom side 105 of the assembly 100. The angulation of the third part 164 may be selected to account for mounting the header runner 150 to battens on a sloped roof, considering the tolerances on such battens may vary significantly. Additionally, a front side of the first part 157 and a top side of the second part 163 define a space 167.

As shown in the front view of FIG. 12, the first part 157 of the header runner 150 has a left side feature 158 that includes a projection, corresponding in substantial part to the left side feature of the left side rail 110, and a right side feature 160 that includes a projection, corresponding in substantial part to the right side feature of the right side rail 130. The left side feature 158 forms a left side space 159 into which a corresponding right side feature 160 (of a further solar assembly) or a right side of a roof tile can be received to loosely couple the header runner 150 to the further solar assembly or the roof tile, and the right side feature 160 forms a right side space 161 into which a corresponding left side feature 158 (of a further solar assembly) or a left side of a roof tile can be received to loosely couple the header runner 150 to the further solar assembly or the roof tile. Accordingly, the shape of the first part 157 of the header runner 150 is designed for compatibility with adjacent solar assemblies and/or roof tiles.

Additionally, the first part 157 of the header runner 150 includes a hole 162 adjacent to the left side 151 for fastening the left side rail 110 to the header runner 150 and a hole 162 adjacent to the right side 152 for fastening the right side rail 130 to the header runner 150, e.g., by fastener 250 of FIG. 25. The third part 164 (flap 164) includes first holes 165 adjacent to the front side 155 of the header runner 150 for fastening the third part 164 to the firestop plate 200 via the wind clip 220, e.g., by fastener 251 of FIG. 26, to be described in greater detail below. The third part 164 includes second holes 166 set back from the first holes 165 for fastening the third part 164 to roof support structure, e.g., a horizontal batten (wooden beam). During installation of the frame 107, the header runner 150 can be fastened to horizontal wooden battens on which the header runner 150 rests via screws that are drilled into the horizontal wooden battens.

FIGS. 14-16 show views of a front side trim 170 of the solar assembly 100 according to various example embodiments. The front side trim 170 is described with regard to a first side 171 (left side 171 or left end 171), a second side 172 (right side 172 or right end 172), a third side 173 (bottom side 173 or bottom end 173), a fourth side 174 (top side 174 or top end 174), a fifth side 175 (front side 175 or front end 175) and a sixth side 176 (rear side 176 or rear end 176). In this example, a length of the front side trim 170 refers to a distance in the y-direction; a width of the front side trim 170 refers to a distance in the x-direction, and a depth of the front side trim 170 refers to a distance in the z-direction.

The front side trim 170 comprises a longitudinal member with an extruded profile that defines a slot 185 (front side slot 185) extending along its length. The slot 185 is open on one side, facing toward the rear side 102 of the assembly 100 (x-direction). The slot 185 is sized and shaped to slidably receive a front side 303 of the solar laminate assembly 300 therein, to be described in greater detail below. The extruded profile of the front side trim 170 defines a groove 187 (slot or space) adjacent to its bottom side 173. The slot 187 is open on one side, facing toward the top side 106 of the assembly 100. The slot 187 is sized and shaped to slidably receive a feature or projection of a leading edge wind clip 240, to be described in greater detail below.

Additionally, the front side trim 170 includes features for fastening the front side trim 170 to further components of the assembly 100, in particular, a hole 182 for fastening the front side trim 170 to the left side rail 110 and a hole 182 for fastening the front side trim 170 to the right side rail 130.

The front side trim 170 extends longitudinally (y-direction) from the first side 171 to the second side 172. The front side trim 170 is configured to be fastened to the left side rail 110 at a position adjacent to the first side 171 and to the right side rail 130 at a position adjacent to the second side 172. The front side trim 170 is described with regard to a first part 177 (front part 177), a second part 183 (top part 183), a third part 184 (middle part 184), and a fourth part 186 (bottom part 186), each part extending longitudinally from the first side 171 (or a location adjacent thereto) to the second side 172 (or a location adjacent thereto). The first part 177 includes a feature on the first side 171 and a feature on the second side 172. A profile of the front side trim 170, as shown in the side view of FIG. 16, is uniform throughout the length of the second part 183, the third part 184 and the fourth part 186.

The first part 177 of the front side trim 170 extends vertically (z-direction) from the top side 174 to the bottom side 173 and defines the front surface 175 of the front side trim 170. The second part 183 of the front side trim 170 extends from the top of the second part 183 toward the rear side 104 of the assembly 100. The third part 184 of the front side trim 170 includes a first portion and a second portion extending from a medial portion of the first part 177 toward the rear side 104 of the assembly 100 and spaced to form the front side slot 185 facing the rear side 104 of the assembly 100. The fourth part 186 of the front side trim 170 includes a first portion extending from the bottom side 173 of the first part 177 toward the rear side 104 of the assembly 100 and a second portion extending from the rear side of the first portion toward the top side 174 of the front side trim 170.

As shown in the front view of FIG. 15, the first part 177 of the front side trim 170 has a left side feature 178 that includes a projection, corresponding in substantial part to the right side feature of the right side rail 130, and a right side feature 180 that includes a projection, corresponding in substantial part to the left side feature of the left side rail 110. The left side feature 178 forms a left side space 179 into which a corresponding right side feature 180 (of a further solar assembly) or a right side of a roof tile can be received to loosely couple the front side trim 170 to the further solar assembly or the roof tile, and the right side feature 180 forms a right side space 181 into which a corresponding left side feature 178 (of a further solar assembly) or a left side of a roof tile can be received to loosely couple the front side trim 170 to the further solar assembly or the roof tile. Accordingly, the shape of the first part 177 of the front side trim 170 is designed for compatibility with adjacent solar assemblies and/or roof tiles. Additionally, the first part 177 of the front side trim 170 includes a hole 182 adjacent to the left side 171 for fastening the left side rail 110 to the front side trim 170 and a hole 182 adjacent to the right side 172 for fastening the right side rail 130 to the front side trim 170.

Accordingly, the front trim 170 includes a rear-facing slot 185 sized and shaped for slidably receiving a front side 303 of the laminate 300, e.g., after sliding the laminate 300 into the slots of the side rails 110, 130 and into the rear slot(s) 232 of the wind clip(s) 220, the front trim 170 can be slid over the front side of the laminate 300 then fastened to the side rails 110, 130. It is noted that the front trim 170 may not be fastened to the roof structure or to a lower adjacent solar module. In the fully assembled state, the front of the solar assembly including the front trim rests top of a lower adjacent solar module or standard roof tile. In some embodiments, a leading edge wind clip 240 is coupled to the front trim 170 and screwed into the header side (i.e., top) of a lower adjacent concrete tile, to be described in greater detail below.

In further aspects of the present disclosure, the exemplary solar assembly further includes a firestop plate designed to enable a Class A fire rating for the assembly. Class A fire certification includes placing a burning brand block atop the assembly, the burning brand reaching a temperature of ~1400 F. The firestop plate creates the barrier needed between the burning material and the roof deck to prevent the roof support structure from catching fire.

The firestop plate can be formed from a material such as, e.g., galvanized steel. The firestop plate can be laser cut or punched from a steel sheet. In other embodiments, the firestop plate can incorporate additional materials to optimize thermal performance, manufacturing costs and/or weight of the firestop plate.

FIGS. 17-19 show view of a firestop plate 200 of the solar assembly 100 according to various exemplary embodiments. The firestop plate 200 is described with regard to a first side 201 (front side 201 or front end 201), a second side 202 (rear side 202 or rear end 202), a third side 203 (left side 203 or left end 203), a fourth side 204 (right side 204 or right end 204), a fifth side 205 (bottom side 205 or bottom end 205) and a sixth side 206 (top side 206 or top surface 206). In this example, a length of the firestop plate 200 refers to a distance in the y-direction; a width of the firestop plate 200 refers to a distance in the x-direction, and a depth of the firestop plate 200 refers to a distance in the z-direction.

The firestop plate 200 is formed from a sheet to include a first part 207, i.e., a body of the firestop plate, and additional material extending off each side of the first part 207 that can be bent or pressed into an orientation that forms an angle with the first part 207. In particular, the firestop plate 200 further includes a second part 208, i.e., a left part 208, bent or pressed to curve 90 degrees relative to the first part 207 toward a top of the assembly 100; a third part 210, i.e., a right part 210, bent or pressed to curve 90 degrees relative to the first part 207 toward a top of the assembly 100; a fourth part 212, i.e., a rear part 212, bent or pressed to curve approximately 10 degrees relative to the first part 207 toward a top of the assembly 100; and a fifth part 214, i.e., a front part 214, bent or pressed to curve approximately 90 degrees relative to the first part 207 toward the bottom of the assembly 100. The second part 208 includes holes 209 cut or punched for fastening the firestop plate 200 to the left side rail 110; the third part 210 includes holes 211 cut or punched for fastening the firestop plate 200 to the right side rail 130; and the fourth part 212 includes holes 213 cut or punched for fastening the firestop plate 200 to the rear side header runner 150 (e.g., by the wind clip 220).

The firestop plate 200 can be fastened to the frame 107. The sub-assembly 260 (first module) of the solar assembly 100 may include the left side rail 110, the right side rail 130, the rear side header runner 150 and the firestop plate 200 fastened to the rear side header runner 150 via one or more wind clips 220, to be described below.

After the laminate assembly 300 (second module) is installed in the frame 107, the laminate 310 and the firestop plate 200 are generally oriented on xy-planes and spaced by a distance. Additionally, the front side 201 of the firestop plate 200 and the front trim 170 are spaced by a distance in the x-direction, i.e., the firestop plate 200 does not extend to the front ends of the left side rail 110 and the right side rail 130, as shown below in FIG. 28.

In further aspects of the present disclosure, the exemplary solar assembly further includes a wind clip (a first wind clip or a rear side wind clip) that functions as a receiver for stabilizing the rear side of the laminate and enables compliance with wind uplift standards and/or requirements set by industry and/or governmental entities. For the solar assembly in the fully assembled state, the wind clip affixes the laminate to the frame as a mechanism to meet, e.g., Underwriters Laboratories (UL) wind uplift standards (UL 1897 Roof Material Wind Uplift Standards) and to meet Florida's High Velocity Hurricane Zone requirements (FBC HVHZ FL17670-R3 (194 mph Vult wind rating)).

The wind clip can be formed from a material such as, e.g., aluminum, by a process such as, e.g., extrusion. The wind clip comprises an extruded shape forming a slot suitable for slidably receiving the rear side of the laminate. In some embodiments, two wind clips are used in the assembly. In other embodiments, greater than two wind clips are used in the assembly. The wind clip(s) can be fixed to the header runner and the firestop plate by fasteners, e.g., rivets.

FIGS. 20-21 show a wind clip 220 of the solar assembly 100 according to various exemplary embodiments. The wind clip 220 comprises an extruded shape that is described with regard to a first part 221, a second part 227, and a third part 233, as shown in FIG. 20. It should be understood that these terms are used flexibly and for ease of description. The first part 221 includes a hole 223 through which a fastener fastens the wind clip 220 to the firestop plate 200 and the header runner 150.

As shown in FIG. 21, considered in the xz-plane, the first part 221 of the wind clip 220 includes a first portion 222 extending horizontally and defining a bottom side of the wind clip 220, a first curve 224 curving from a rear side of the first portion 222 toward a top side of the wind clip 220, a second portion 225 extending vertically and defining a rear side of the wind clip 220, and a second curve 226 curving from a top side of the second portion toward a front side of the wind clip 220. The first portion 222 includes a hole 223 therein for fastening the wind clip 220 to the firestop plate 200 and the rear side header runner 150.

The second part 227 of the wind clip 220 defines the rear side slot 232 of the wind clip 220. The rear side slot 232 is sized and shaped for slidably receiving the rear side 304 of the laminate 300. During assembly, the wind clip 220 is oriented so that the slot 232 faces toward the front side 103 of the assembly 100 and is then fastened to the rear side header runner 150 and the firestop plate 200 by the fastener. The second part 227 includes a first portion 228 (a lower horizontal portion) defining a bottom side of the slot 232, a second portion 230 defining a rear side of the slot 232, and a third portion 231 (an upper horizontal portion) spaced from the first portion 228 and defining a top side of the slot 232. It is noted that the first portion 228 defining the bottom of the slot 232 includes a curve and an extension 229 toward the bottom side 105 of the assembly 100 to facilitate the rear side 304 of the solar laminate 300 sliding into the slot 232 and to provide additional support and/or stability to the laminate 300 once engaged with the wind clip 220, e.g., to prevent sagging of the laminate 300.

The third part 233 of the wind clip 220 includes a first portion 234 comprising a first curve extending from a top side of the second part toward the rear and the top side of the wind clip 220 and a second curve extending from the first curve toward the top side and continuing to curve toward the front side of the wind clip 220. The third part 233 of the wind clip 220 further includes a second portion 235 extending from the first portion 234 toward the front side of the wind clip 220 and a third portion 236 that curves off the second portion 235 toward the bottom side of the wind clip 220. The third part 233 is shaped to attach to a further solar assembly above the solar assembly 100, e.g., by clipping into the front trim of the further solar assembly, to lock the assemblies together and prevent wind uplift.

In further aspects of the present disclosure, the exemplary solar assembly further includes a leading edge wind clip (a second wind clip or a front side wind clip) that functions as a stabilizer for the front end of the assembly. A projection (e.g., pin) of the leading edge wind clip can be received in the groove defined at the bottom of the front trim and the body of the leading edge wind clip can be fastened to a lower adjacent roof tile by a slot formed in the body. This provides an anchoring force between the front side of the assembly and the roof, e.g., to resist the translation of the front side of the assembly due to wind forces.

FIGS. 22-24 show views of a leading edge wind clip 240 of the solar assembly 100 according to various exemplary embodiments. The leading edge wind clip 240 comprises an extruded shape that is described with regard to a first part 241, e.g. a body of the leading edge wind clip 240, and a second part 243 for coupling to the front trim 170. It should be understood that these terms are used flexibly and for ease of description.

Considered in the yz-plane, the first part 241 of the leading edge wind clip 240 includes a first part 241 (or a body) extending horizontally. The first part 241 includes an opening 242 for fastening the leading edge wind clip 240 to a lower adjacent roof tile. The second part 243 extends from a front side of the first part 241, curving toward the top side into a first portion 244 extending toward the top side, curving toward the front side into a second portion 245 extending toward the front side, and curving toward the bottom side into a third portion 246 extending toward the bottom side. The third portion 246 comprises a projection that can be received in the groove 187 of the front side trim 170. A slot 247 is defined between the first portion 244, the second portion 245 and the third portion, the slot 247 being open to the bottom side of the leading edge wind clip 240. The bottom projection of the front side trim 170, in particular, the fourth part 186 described above in FIGS. 14-16, can be received in the slot 247. Accordingly, the leading edge wind clip 240 and the front trim 170 can be loosely coupled. The first part 241 can then be fastened to the lower adjacent roof tile to provide a loose coupling between the front trim 170 and the roof. The leading edge wind clips 240 are permitted to slide longitudinally along the front trim, but the front trim is impeded from translating away from the roof, e.g., by a wind force. In some embodiments, two leading edge wind clips 240 are used, e.g., as shown below in FIG. 49. In other embodiments, less than two or greater than two leading edge wind clips 240 can be used.

The solar assembly as described herein can be assembled by fasteners. FIGS. 25-27 show exemplary fasteners of the solar assembly according to various exemplary embodiments. The fastener 250 of FIG. 25 comprises a screw and can be used to join the left side rail 110 to the rear side header runner 150 and the front trim 170. The fastener 251 of FIG. 26 comprises a rivet and can be used to join the wind clip 220 to the firestop plate 200 and the third part 164 of the header runner 150. The fastener 252 of FIG. 27 comprises a rivet and can be used to join the firestop plate 200 to the left side rail 110 and the right side rail 130.

In some embodiments, the solar assembly has a modular design. In some embodiments, a sub-assembly of the modular solar assembly (including a majority of the frame), e.g., a first module, can be installed on the roof in a first installation step and the laminate, e.g., a second module, can be installed in a second installation step, effectively decoupling the frame installation from the laminate installation. The solar laminate can be easily inserted into or removed from the pre-installed frame, enabling straightforward installation, servicing, maintenance, and upgrades to the system. In some embodiments, the sub-assembly (first module) can include the left side rail, the right side rail, the header runner, the firestop plate and the wind clips.

FIGS. 28-29 show views of a sub-assembly 260 of the modular solar assembly 100. The sub-assembly 260, e.g., a first module that would be installed on the roof prior to sliding in the solar laminate and adding the front trim 170, includes the left side rail 110, the right side rail 130, the rear side header runner 150, the firestop plate 200, the wind clips 220, and the fasteners for joining these components as described above. The left side rail 110 and the right side rail 130 are fastened to the header runner 150 with fasteners such as, e.g., the screws shown in FIG. 25. The firestop plate 200 and the wind clip 220 can be fastened to the header runner 150 with fasteners such as, e.g., the rivets shown in FIG. 26. The firestop plate 200 can be fastened to the left side rail 110 and the right side rail 130 with fasteners such as, e.g., the rivets shown in FIG. 27.

The sub-assembly 260 can be assembled prior to shipping. The sub-assembly 260 can be installed on a roof prior to installing the laminate, e.g. a second module. The header runner 150 can be fastened to roof deck support structure (e.g., wooden battens), to be described in greater detail below with regard to FIGS. 42-43.

It should be understood that the front trim 170 can be shipped with the sub-assembly 260 shown in FIGS. 28-29 (either fastened to the side rails or loosely). The front trim 170 can be fastened to the side rails either prior to or during installation of the frame 107, however, the front trim 170 would need to be removed to install the solar laminate 300 and then refastened to the side rails (with the front side of the laminate 300 received in the front side slot 185 of the front trim 170) to complete the installation of the solar laminate 300.

To fully assemble the solar assembly 100, the solar laminate 300 is slid into the sub-assembly 260. The left side slot 125 of the left side rail 110 slidably receives the left side of the laminate 300 and the right side slot 143 of the right side rail 130 slidably receives the right side of the laminate 300 via the front side 103 of the assembly 100. The laminate 300 is slid toward the rear side 104 of the assembly 100 until it reaches the wind clips 220. The wind clips 220 should be oriented so that the laminate 300 can continue to slide into the rear side slots 232 of the wind clips 220. When the laminate 300 is fully inserted, the front side trim 170 can be joined to the remainder of the frame 107. The front side trim 170 can be aligned with the laminate 300 so that the third part 184 (middle part 184) defining the front side slot 185 can be slid over the front side of the laminate 300, i.e., the front side of the laminate 300 is slidably received within the front side slot 185 of the front side trim 170. The front side trim 170 can then be fastened to the side rails 110, 130 to enclose the laminate 300 within the frame 107 and fully assemble the modular solar assembly 100. In some cases, one or more leading edge wind clips 240 can be added to secure the front side trim 170 to the roof, e.g., to an adjacent lower roof tile, to be described in greater detail below.

FIGS. 30-31 show section views of the solar assembly 100 in a partially assembled state according to various exemplary embodiments. The laminate 300 is shown fully inserted into the frame, i.e., with the left side of the laminate 300 slidably received in the left side slot 125 of the left side rail 110 and with the right side of the laminate 300 slidably received in the right side slot 143 of the right side rail 130.

In some embodiments, a solar laminate assembly comprises the solar laminate, the solar laminate including a solar cell encapsulated by front glass and a PET back sheet. In some embodiments, the laminate is composed of layers including a top glass layer, a first encapsulant layer, a solar cell matrix layer, a second encapsulant layer, and a polymeric back sheet. The laminate assembly can further comprise a cell tabbing ribbon, a busbar, connectors, diodes, a junction box, potting material, cables, junction box (Jbox), frame adhesive, and an edge protector.

FIGS. 32-33 shows a laminate assembly 300 of the solar assembly 100 according to various exemplary embodiments. The laminate assembly 300 is described with regard to a first side 301 (left side 301), a second side 302 (right side 302), a third side 303 (front side 303) and a fourth side 304 (rear side 304). The laminate assembly 300 includes a laminate 310 and a laminate edge protector 320. The laminate edge protector 320 is fit around the four sides of the laminate 310, e.g., a left side member 321 is fit around the left side of the laminate 310; a right side member 322 is fit around the right side of the laminate 310; a front side member 323 is fit around the front side of the laminate 310; and a rear side member 324 is fit around the rear side of the laminate 310. Two of the members of the laminate edge protector 320 may meet at a corner of the laminate edge protector 320, as shown in FIG. 33. The dimensions of the members of the laminate edge protector 320 (e.g., a depth thereof) are selected so that the laminate edge protector 320 can slide into the slots of the frame 107 and wind clip(s) 220 of the solar assembly 100 and be snuggly received therein after assembling the solar assembly 100. The laminate edge protector 320 may be formed of a rubber and may function as a shock absorber for the laminate 310.

FIGS. 34-35 show views of the left side member 321 of the laminate edge protector 320 according to various exemplary embodiments. The left side member 321 extends from a first side 325 to a second side 326 and includes a cross-section defining a slot 330 within which the left side of the laminate 310 can be received. The cross-section of the left side member 321 of the laminate edge protector 320 includes a first part 327 (top part 327), a second part 328 (middle part 328), and a third part 329 (middle part 329). These parts form a C-shape that defines the slot 330. It should be understood that each of the members of the laminate edge protector 320 comprise the same cross-section. The left side member 321 and the right side member 322 have an equivalent length (substantially corresponding to a distance between the front side trim 170 and the wind clip 220 of the solar assembly 100 after full assembly) and the front side member 323 and the rear side member 324 have an equivalent length (substantially corresponding to a distance between the left side rail 110 and the right side rail 130 of the solar assembly 100). Accordingly, the laminate edge protector 320 is sized and shaped to slide within the slots of the frame 107 and the wind clip 220.

FIG. 36 shows an exploded view of the laminate 310 of the solar assembly 100 according to various exemplary embodiments. The laminate 310 includes a first layer 311 comprising a top glass layer; a second layer 312 comprising a first encapsulant layer (e.g., EPE/POE); a solar cell 313 (a third layer 313) comprising a solar cell layer (e.g., a quarter-cut cell matrix); a fourth layer 314 comprising a second encapsulant layer (e.g., EPE/POE); and a fifth layer 315 comprising a polymeric backsheet. Accordingly, the solar cell 313 is encapsulated.

FIGS. 37-39 show views of the laminate assembly 300 including the solar cell 313 and a split junction box arrangement according to various exemplary embodiments. As shown in the top view of FIG. 37, a first junction box 340 can be located on the left side 301 of the laminate assembly 300 and a second junction box 341 can be located on the right side 302 of the laminate assembly 300. FIG. 38 shows a first region 342 comprising an acceptable junction box region on the left side 301 of the laminate assembly 300 and a second region 343 comprising an acceptable junction box region on the right side 302 of the laminate assembly 300. FIG. 39 shows a circuit diagram for the split junction box arrangement. A split junction box can enhance efficiency, improve shading performance, and prolong the lifespan of the solar module. However, a split junction box is not required, and a singular junction box configuration may be used.

FIGS. 40-41 show views of the solar cell 313 according to various exemplary embodiments. FIG. 40 shows engineering drawings of the solar cell 313 according to one example and FIG. 41 shows a cell cut design according to one example.

Roof tiles are commonly installed on roof deck structure sized, spaced, and arranged to support the roof tiles. As described above, the solar assembly can be designed in view of the characteristics of existing roof tiles and existing types of support structure.

FIG. 42-43 show views of a roof assembly 350 including roof tiles 351 installed on horizontal support members 355 on a roof plane 354 according to one example. In this example, the horizontal support members 355 comprise arched wooden battens that permit airflow through arches cut into the lower side of the members 355. In other embodiments, the horizontal roof support members can comprise standard rectangular beams without arches.

As shown in FIG. 43, the roof tiles 351 are formed with a tongue and groove profile. A tongue 352 of a first roof tile 351 interlocks with a groove 353 of a second roof tile 351. As described above, the left side rail 110 of the solar assembly 100 is shaped to substantially match the groove profile 353 of the roof tile 351 and the right side rail 130 of the solar assembly 100 is shaped to substantially match the tongue profile 352 of the roof tile 351.

Multiple solar assemblies can be installed on a roof in a manner similar to the installation of standard roof tiles. The solar assembly is designed to replace one or multiple roof tiles. Each solar assembly is compatible for coupling to or abutting either another solar assembly or a roof tile. For a solar assembly having a vertically adjacent solar assembly, the front side of the upper solar assembly can rest on the rear side (e.g., header runner) of the lower solar assembly without any additional fastening. This design concept mirrors the installation method of flat concrete tiles, with a roof tile being mounted to a wooden batten, then the tile above it is installed such that it slightly overlaps-the upper rests on the lower, but they are not fastened to each other.

FIGS. 44-52 show views of a roof assembly 360 including multiple solar assemblies 100 according to various exemplary embodiments. As shown in the view of FIG. 44, a house 361 includes a roof 362 which, in this example, includes two roof planes 363. The roof plane 363 includes horizontal support members 364. A roof plane 363 can include a tiled portion 365 including one or more roof tiles 366 and a solar portion 367 including one or multiple solar assemblies 100. In this example, the solar portion 367 includes nine solar assemblies 100, with three horizontal rows of three arranged vertically on the roof plane 363. As shown in the views of FIGS. 45-47, solar assemblies 100 vertically adjacent to one another include an upper solar assembly 100 having a front end resting on a back end of a lower solar assembly 100, with the lower solar assembly 100 fastened to a horizontal support member 364. The view of FIG. 47 removes a laminate assembly 300 from the image to show the relative positioning of components of the assemblies 100.

FIGS. 48-50 show views of a leading edge wind clip 240 of the solar assembly 100 fastened to a roof tile 366 according to various exemplary embodiments. In this example, two leading edge wind clips 240 are used to secure the front trim 170 of a solar assembly 100 to respective roof tiles 366. The leading edge wind clips 240 can be fastened to the roof tile 366 by a fastener 368.

The arrangement of solar assemblies as described above can enable a passive cooling effect. Those skilled in the art understand that, as the temperate of a solar cell increases, the cell efficiency decreases. Increased temperate also decreases the lifespan of the cells. Accordingly, it can be beneficial to design a solar assembly so that the solar cell can be cooled, particularly in high temperature regions. In some embodiments, the exemplary modular solar assembly can be passively cooled by airflow between the laminate and the firestop. Leveraging passive cooling for BIPV products is unique and also critical for improving module efficiency and longevity.

As shown above in FIGS. 46-47 and described with regard to various preceding Figures, the firestop plate is substantially parallel to the solar laminate and the two components are separated by a distance, forming a space therebetween. This space is open to the environment beneath the solar assembly on its front side and is open to the environment atop the solar assembly on its rear side.

With regard to the front side, the firestop plate is shorter than the solar laminate, such that a gap is formed between the firestop plate and the front trim, exposing the front of the solar assembly to air flow through the bottom of the gap. With regard to the rear side, the solar laminate and the fire stop extend only so far as the wind clips fastened to the flat part of the header runner. The space atop the flat part of the header runner exposes the rear of the solar assembly to air flow through the rear spacing between the laminate and the firestop. These openings permit air flow between the laminate and the firestop, effectively cooling the solar cell encapsulated within the laminate. FIG. 51 shows an illustration of the passive cooling effect imparted on the roof assembly 360. FIG. 52 shows an illustration of the passive cooling effect imparted on a further roof assembly 370.

Considering multiple solar assemblies arranged vertically (on top of one another), a continuous channel is formed through the solar assemblies. The rear opening of a lower solar assembly opens directly into the front opening of a higher solar assembly due to the overlap of the front end of the higher solar assembly and the rear end of the lower solar assembly. Accordingly, a vent is formed beneath the solar laminates, permitting air to passively pass through by convection.

Additionally, the space between the bottom of the solar assembly (the bottom of the firestop plate) and the roof deck forms a lower vent permitting air to passively pass through by convection. There can be an intake at the bottom (front) of the roof plane and an exhaust at the top (back) of the roof plane. Arched battens would further contribute to the passive cooling effect by providing a lower vent between the solar assemblies (and/or standard roof tiles) and the roof deck.

Those skilled in the art understand that solar panels generate direct current (DC) electricity that can be converted to alternating current (AC) electricity downstream from the panels for use in a local grid (e.g., for a house or building) or the wider utility grid serving a geographical area. A solar power inverter converts the DC output of the solar panels into an AC output. In some cases, multiple solar panels are connected in series, forming a string, and each string is connected to a central inverter. In other cases, one or more solar panels are connected to a microinverter, enabling design flexibility and higher data fidelity of system performance.

In some embodiments, one or more instances of the solar assembly are connected to a microinverter. The microinverter can be located in the vent beneath the solar panels to directly cool the microinverter.

It should be understood that, although the exemplary embodiments are described with regard to specific roof tiles (concrete, having certain dimensions, etc.) and types of roofs (sloped, incorporating horizontal wooden beam support structure, etc.), the present disclosure is not limited to these specific tile types and roof types. For example, even with roof tiles having substantially different characteristics from concrete roof tiles (e.g., different materials and/or smaller size), the design of the solar assembly can, in some cases, be adapted to the characteristics of these roof tiles. In another example, vertical battens (i.e., battens sloped in the top-bottom direction of the roof) can be integrated into the roof design and the solar assembly can be modified for compatibility with and fastening to such vertical battens. In this example, the frame of the solar assembly can have additional attachment points to the roof, e.g., via the left side rail 110 and/or the right side rail 130. In some cases, using both horizontal and vertical battens in the roof structure can improve the airflow through the assembly.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalents.

1. An assembly for generating solar power, comprising:
a frame including a left side rail defining a left side of the assembly, a right side rail defining a right side of the assembly, a rear side header runner defining a rear side of the assembly, and a front side trim defining a front side of the assembly, the left side rail including a left side slot, the right side rail including a right side slot, and the front side trim including a front side slot, the rear side header runner including a first part defining the rear side of the assembly and a second part extending toward an interior of the frame, the frame configured for installation on a roof by fastening the rear side header runner to roof support structure;
a solar laminate comprising a solar cell, the solar laminate including a left side, a right side, a rear side and a front side, the solar laminate sized and shaped so that the left side thereof is receivable in the left side slot of the left side rail, the right side thereof is receivable in the right side slot of the right side rail, and the front side thereof is receivable in the front side slot of the front side trim; and
a firestop plate comprising a sheet sized and shaped for attachment to the left side rail, the right side rail and the rear side header runner, the firestop plate including a left side portion fastened to the left side rail, a right side portion fastened to the right side rail, and a rear side portion fastened to the second part of the rear side header runner, wherein the rear side portion of the firestop plate overlaps the second part of the rear side header runner,
wherein the solar laminate and the firestop plate are separated by a first distance forming a space therebetween,
wherein the firestop plate and the front side trim are separated by a second distance forming a first gap therebetween,
wherein the rear side of the solar laminate and the first part of the rear side header runner are separated by a third distance forming a second gap therebetween, and
wherein the first gap is in communication with the second gap via the space so that a vent is formed between the solar laminate and the firestop plate, permitting air to flow through the space.

2. The assembly of claim 1, further comprising:
a wind clip including a rear side slot open to and facing toward the front side of the assembly, wherein the rear side of the solar laminate is receivable in the rear side slot of the wind clip, wherein the rear side header runner, the firestop plate and the wind clip are fastened together by a fastener extending through a bottom part of the wind clip, the rear side portion of the firestop plate and the second part of the rear side header runner.

3. The assembly of claim 2, wherein the rear side slot defines a rear location of the solar laminate relative to the frame, the rear location separated from the first part of the rear side header runner by the third distance such that the second gap is defined between the first part of the rear side header runner and the solar laminate.

4. The assembly of claim 3, wherein the second gap is open to a top side of the assembly, permitting the air in the space to exit the space by convection.

5. The assembly of claim 2, wherein the firestop plate extends parallel to the solar laminate from the rear side portion of the firestop plate to a front end of the firestop plate, wherein the front end of the firestop plate is separated from a front trim by the second distance such that the first gap is defined between the firestop plate and the front trim.

6. The assembly of claim 5, wherein the first gap is open to a bottom side of the assembly, permitting the air to enter the space by convection.

7. The assembly of claim 1, wherein the solar laminate generates heat and the air flowing through the vent passively cools the solar laminate.

8. The assembly of claim 1, wherein the roof on which the frame is configured for installation is a sloped roof plane and the roof support structure includes horizontal members fixed to the sloped roof plane, wherein installation of the frame on a first horizontal member of the roof support structure of the sloped roof plane positions the first gap lower than the second gap, further enabling the air to flow through the vent by convection.

9. The assembly of claim 8, wherein the assembly is sized and shaped so that the installation of the frame on the first horizontal member causes a front end of the assembly to overlap a second horizontal member lower on the sloped roof plane,
wherein a further assembly installed on the second horizontal member including a further second gap permits air to flow from the further assembly into the first gap of the assembly, forming a continuous vent between the assembly and the further assembly.

10. The assembly of claim 8, wherein the assembly is sized and shaped so that the installation of the frame on the first horizontal member causes a front end of the assembly to overlap a second horizontal member lower on the sloped roof plane and a further assembly installed on a third horizontal member higher on the sloped roof plane overlaps the first horizontal member,
wherein the further assembly installed on the third horizontal member including a further first gap permits air to flow from the second gap of the assembly into the further first gap of the further assembly, forming a continuous vent between the assembly and the further assembly.

11. The assembly of claim 1, further comprising:
a microinverter connected to the solar laminate,
wherein horizontal members of the roof support structure comprise spaces cut therein to permit air flow through the spaces, forming a further vent,
wherein the microinverter is positioned between a bottom side of the firestop plate and a sloped roof plane and the air flow through a second vent passively cools the microinverter.

12. A system for generating solar power, comprising:
a first assembly comprising:
a first frame including a first left side rail, a first right side rail, a first rear side header runner, and a first front side trim, the first left side rail including a first left side slot, the first right side rail including a first right side slot, and the first front side trim including a first front side slot;
a first solar laminate comprising a first solar cell, the first solar laminate sized and shaped to slide within the first left side slot of the first left side rail, the first right side slot of the first right side rail, and the first front side slot of the first front side trim to install the first solar laminate in the first frame; and
a first firestop plate fastened to the first left side rail, the first right side rail, and the first rear side header runner,
wherein the first solar laminate and the first firestop plate are separated by a first space therebetween,
wherein the first firestop plate and the first front side trim are separated by a first front gap therebetween,
wherein a first rear side of the first solar laminate and a part of the first rear side header runner are separated a first rear gap therebetween, and
wherein the first front gap is in communication with the first rear gap via the first space so that a first vent is formed between the first solar laminate and the first firestop plate, permitting air to flow through the first space; and
a second assembly comprising:
a second frame including a second left side rail, a second right side rail, a second rear side header runner, and a second front side trim, the second left side rail including a second left side slot, the second right side rail including a second right side slot, and the second front side trim including a second front side slot;
a second solar laminate comprising a second solar cell, the second solar laminate sized and shaped to slide within the second left side slot of the second left side rail, the second right side slot of the second right side rail, and the second front side slot of the second front side trim to install the second solar laminate in the second frame; and
a second firestop plate fastened to the second left side rail, the second right side rail, and the second rear side header runner,
wherein the second solar laminate and the second firestop plate are separated by a second space therebetween,
wherein the second firestop plate and the second front side trim are separated by a second front gap therebetween,
wherein a second rear side of the second solar laminate and a part of the second rear side header runner are separated a second rear gap therebetween, and
wherein the second front gap is in communication with the second rear gap via the second space so that a second vent is formed between the second solar laminate and the second firestop plate, permitting air to flow through the second space,
wherein the first frame is configured for installation on a sloped roof plane by fastening the first rear side header runner to a first horizontal member of roof support structure and the second frame is configured for installation on the sloped roof plane by fastening the second rear side header runner to a second horizontal member of the roof support structure, the second horizontal member located higher on the roof plane such that second assembly overlaps the first assembly,
wherein the second front gap of the second assembly overlaps the first rear gap of the first assembly, forming a continuous vent between the first assembly and the second assembly.
